(19) United States
(12) Patent Application Publication
(10) Pub. No.: US 2025/0238975 A1
(43) Pub. Date: Jul. 24, 2025

(54) PIXEL-BASED IMAGE PROCESSING METHOD AND AN ELECTRONIC DEVICE INCLUDING A USER INTERFACE IMPLEMENTED WITH THE METHOD

(71) Applicant: Pebblous Inc., Daejeon (KR)

(72) Inventors: Joo Haeng Lee, Sejong-si (KR); Jeong Won Lee, Daejeon (KR)

(21) Appl. No.: 19/055,514

(22) Filed: Feb. 18, 2025

Related U.S. Application Data
(63) Continuation of application No. PCT/KR2023/001001, filed on Jan. 20, 2023.

(30) Foreign Application Priority Data
Aug. 18, 2022 (KR) 10-2022-0103404
Dec. 23, 2022 (KR) 10-2022-0182838
Dec. 23, 2022 (KR) 10-2022-0182839
Dec. 23, 2022 (KR) 10-2022-0182840

(51) Int. Cl. G06T 11/00; G06T 11/60

(52) U.S. Cl. CPC G06T 11/001; G06T 11/60

(57) ABSTRACT

An electronic device for providing a pixel-based image processing method includes a display and at least one processor. The at least one processor is configured to display a source image using the display, set at least one region of the source image as a reference position, obtain a second pixel group by resetting a plurality of pixels included in a first pixel group of the source image based on the reference position, and display, using the display, a first processed image including the second pixel group.

### CROSS-REFERENCE TO RELATED APPLICATIONS

This application is a bypass continuation of International Application No. PCT/KR2023/001001, filed on Jan. 20, 2023, which is based on and claims priority to Korean Patent Application No. 10-2022-0103404, filed on Aug. 18, 2022, Korean Patent Application No. 10-2022-0182838, filed on Dec. 23, 2022, Korean Patent Application No. 10-2022-0182839, filed on Dec. 23, 2022, and Korean Patent Application No. 10-2022-0182840, filed on Dec. 23, 2022, in the Korean Intellectual Property Office, the disclosures of which are incorporated by reference herein in their entireties.

### BACKGROUND

### Technical Field

The present disclosure relates to an electronic device that performs pixel-based image processing. More particularly, the present disclosure relates to an electronic device that performs various image processing operations set to provide a visual effect using characteristics of pixels.

### Background Art

As the processing technology of image using a computer develops, computer programs are being developed that provide various types of image processing functions to users. In particular, by providing technologies that process an original image to provide various types of processed images, various experiences are provided to users such as editing an image, synthesizing an image, or transferring a style of another image.

In order to solve these problems, there is a need for an image processing technology that provides a new user experience while providing processed images by reflecting the characteristics of the image itself, especially the pixels of the image.

### SUMMARY

### Detailed Description of the Invention

### Technical Problem

An objective of the present disclosure is to provide a processed image that reflects the characteristics of the image by using the original image (source image).

Further, an objective of the present disclosure is to provide various visual experiences according to the image to a user experiencing image processing through an electronic device (or computing device).

The technical solutions presented in this disclosure are not limited to the aforementioned aspects. Additional solutions may be clear to those skilled in the art with reference to the following detailed description and the accompanying drawings.

### Technical Solution

According to an embodiment of the present disclosure, there may be provided an image processing method including the steps of: acquiring a source image by at least one processor operating according to at least a portion of multiple instructions stored in a memory; acquiring a first characteristic value based on at least one unit area included in the source image; and obtaining a first shape image by selecting, among a plurality of shape images included in a first shape image set stored in the memory, a shape image corresponding to the first characteristic value.

Furthermore, according to an embodiment of the present disclosure, there may be provided an electronic device for processing a source image to provide a processed image, the electronic device comprising: a memory in which multiple instructions are stored; and at least one processor operating based on at least some of the multiple instructions. The at least one processor is configured to acquire a source image, acquire a first characteristic value based on at least one unit area included in the source image, receive a first shape image set including a plurality of shape images based on user input, and obtain a first shape image by selecting, among the plurality of shape images, a shape image corresponding to the first characteristic value.

In addition, according to an embodiment of the present disclosure, there may be provided an electronic device for providing a pixel-based image processing method, the electronic device comprising: a display; and at least one processor, wherein the at least one processor is configured to display a source image using the display, set at least one region of the source image as a reference position, obtain a second pixel group by resetting a plurality of pixels included in a first pixel group of the source image based on the reference position, and display, using the display, a first processed image that includes the second pixel group.

Further, according to an embodiment of the present disclosure, in an image processing method, at least one processor operating according to at least some of a plurality of instructions stored in a memory may: acquire a first image and a second image; acquire a first pixel map by displaying a plurality of pixels included in the first image in a coordinate space defined by one or more pixel attributes, and acquire a second pixel map by displaying a plurality of pixels included in the second image in the coordinate space defined by the one or more pixel attributes; and obtain a third image that reflects a first characteristic of the first image and a second characteristic of the second image based on a positional correspondence between the first pixel map and the second pixel map.

In addition, according to an embodiment of the present disclosure, there may be provided an electronic device for providing a processed image based on multiple images, the electronic device comprising: a display; a memory in which multiple instructions are stored; and at least one processor operating based on some of the multiple instructions, wherein the at least one processor is configured to display the first image and the second image using the display, acquire a first pixel map by plotting a plurality of pixels included in the first image in a coordinate space defined by one or more pixel attributes, acquire a second pixel map by plotting a plurality of pixels included in the second image in the same coordinate space, and display, via the display and based on a positional correspondence between the first and second pixel maps, a processed image that reflects a first characteristic of the first image and a second characteristic of the second image.

According to various embodiments, the technical solutions and their effects thereof are not limited to those mentioned solutions above. The solutions and effects that are not mentioned may be clear to those skilled in the art with reference to the following detailed description and the accompanying drawings.

### Advantageous Effects

According to various embodiments, an image customized processing image corresponding to an image characteristic may be provided using a source image.

In addition, according to various embodiments, various visual effects by user experience may be provided by transferring shapes and colors between images using image characteristics.

The effects of the embodiments included in this disclosure are not limited to those described above, and those not described will be apparent to one having ordinary skill in the art from this description and the accompanying drawings.

### BRIEF DESCRIPTION OF THE DRAWINGS

### Description of Drawings

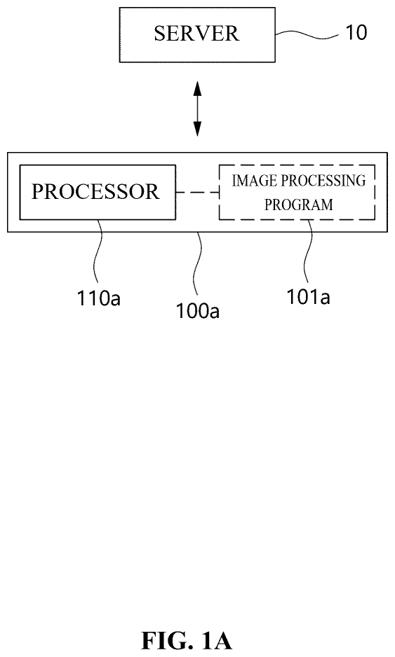

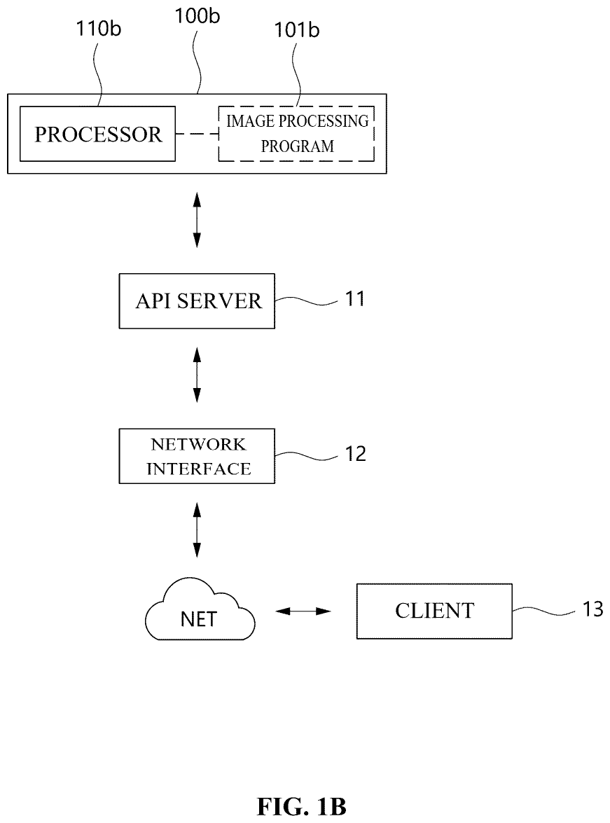

FIG. 1A is a diagram illustrating an embodiment of an image processing system according to various embodiments.

FIG. 1B is a diagram illustrating an embodiment of an image processing system according to various embodiments.

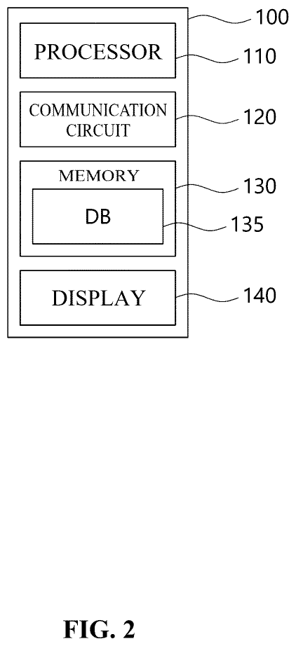

FIG. 2 is a diagram illustrating the configuration of an electronic device that performs an image processing procedure according to various embodiments.

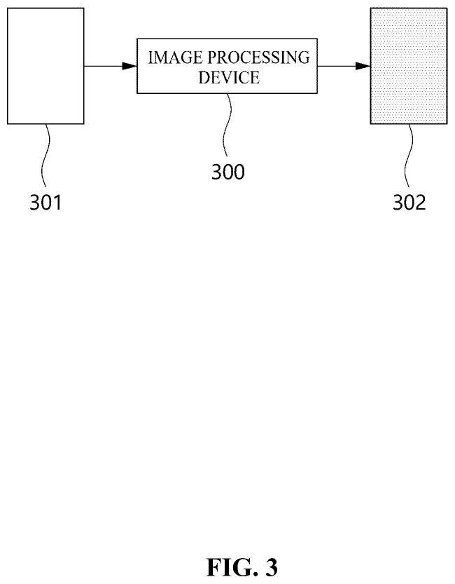

FIG. 3 is a diagram illustrating an image processing procedure of an image processing device according to various embodiments.

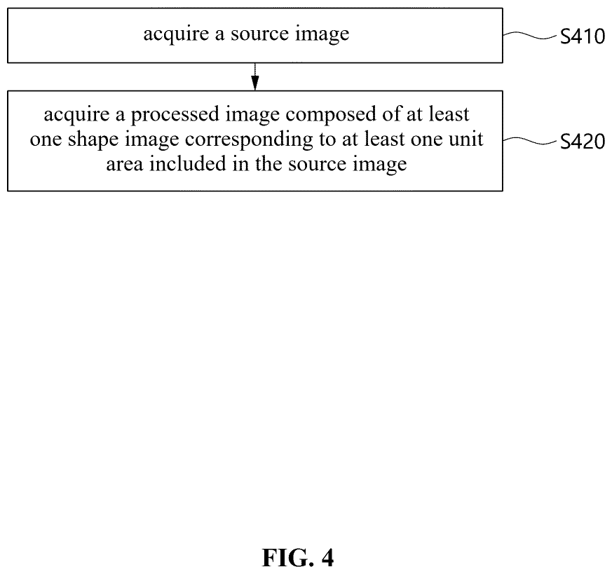

FIG. 4 is a flowchart illustrating a shape image-based image processing method according to various embodiments.

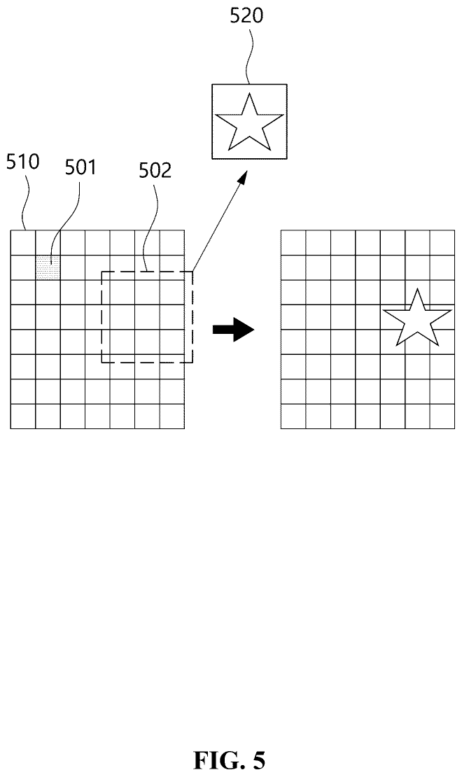

FIG. 5 is a diagram illustrating a shape image corresponding to a unit area of a source image according to various embodiments.

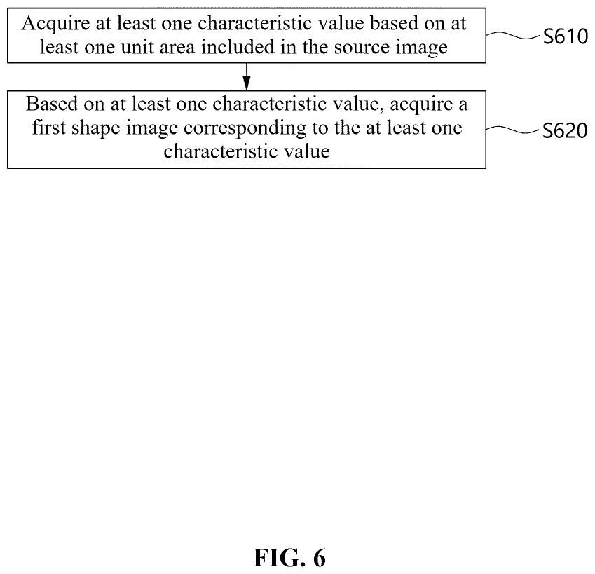

FIG. 6 is a flowchart illustrating a method for converting a unit area of a source image into a shape image by an electronic device according to various embodiments.

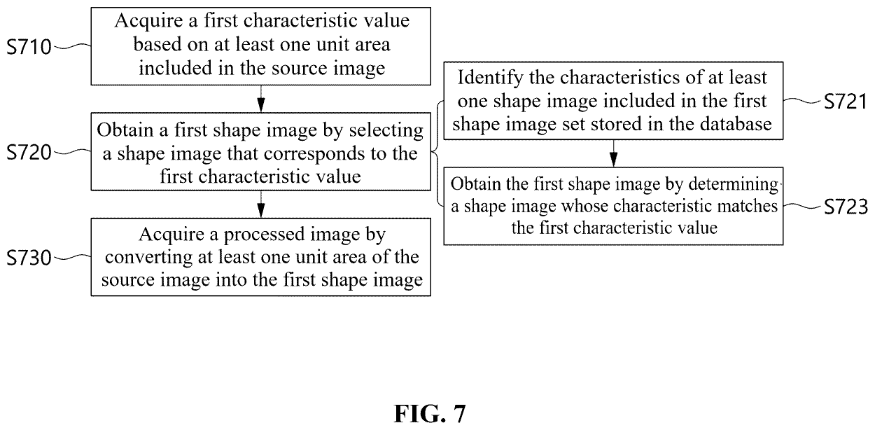

FIG. 7 is a flowchart illustrating an embodiment of a method by which an electronic device acquires a shape image corresponding to a unit area and obtains a processed image, according to various embodiments.

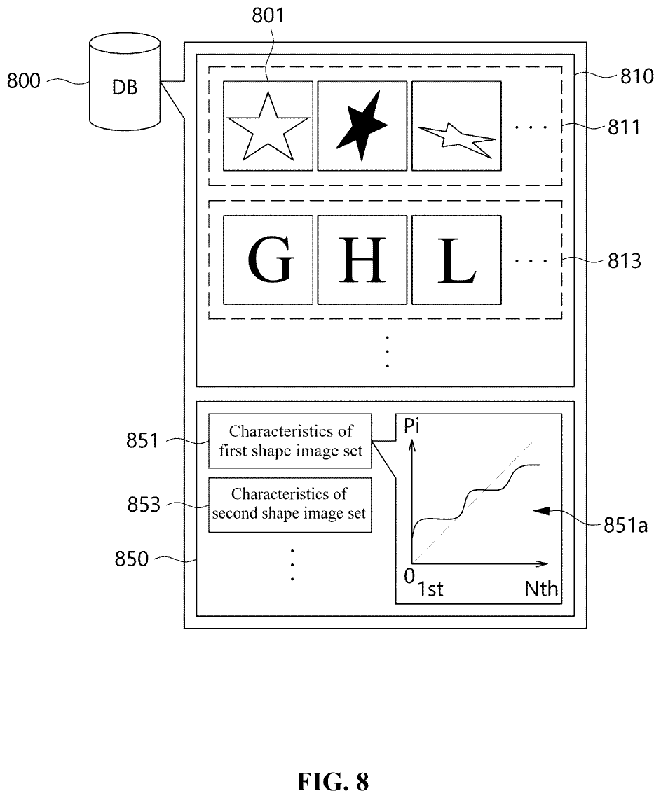

FIG. 8 is a diagram illustrating information related to shape images and the characteristics of those shape images stored in the database of an electronic device, according to various embodiments.

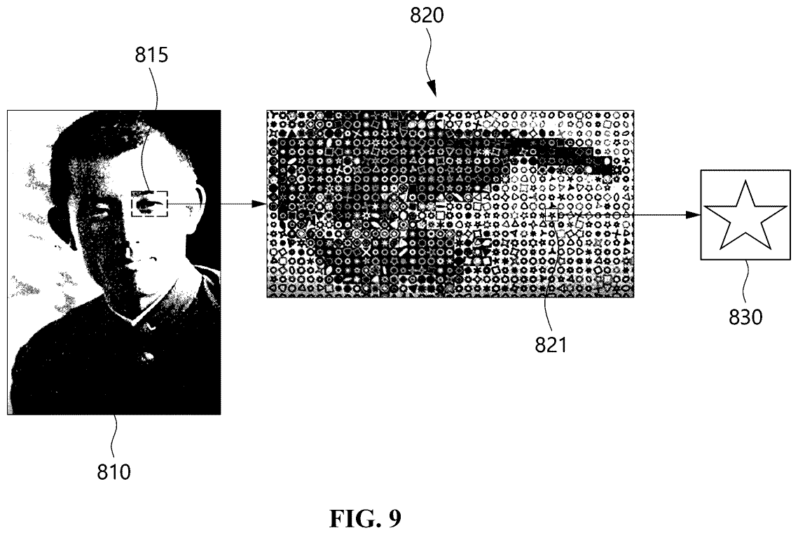

FIG. 9 is a diagram illustrating an example of a processed image acquired by the electronic device according to various embodiments.

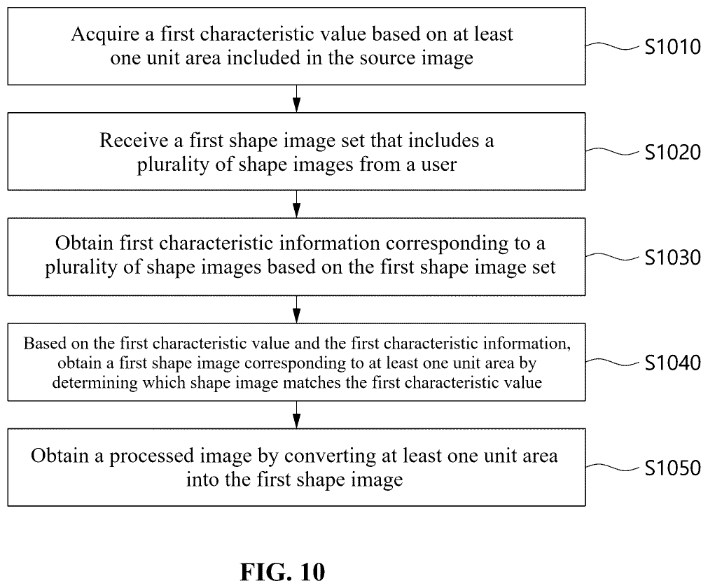

FIG. 10 is a flowchart illustrating another embodiment of a method in which an electronic device acquires a shape image corresponding to a unit area and obtains a processed image, according to various embodiments.

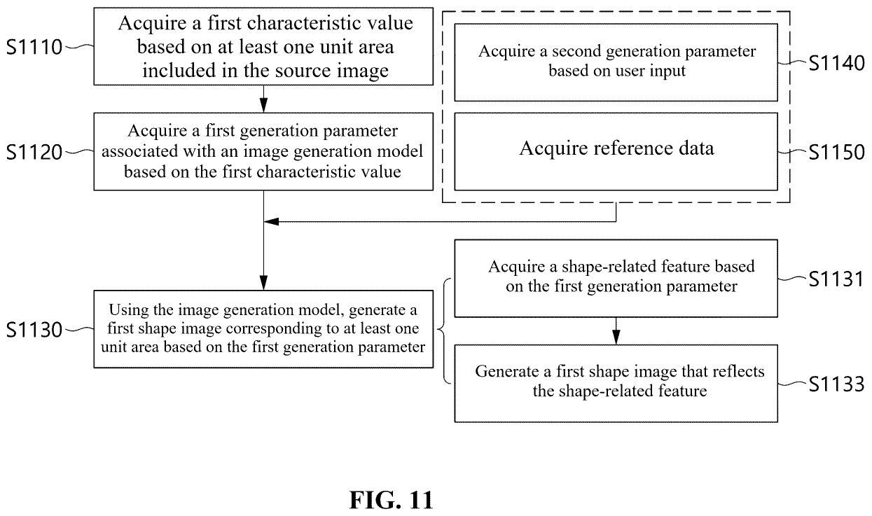

FIG. 11 is a flowchart illustrating yet another embodiment of a method in which an electronic device acquires a shape image corresponding to a unit area and obtains a processed image, according to various embodiments.

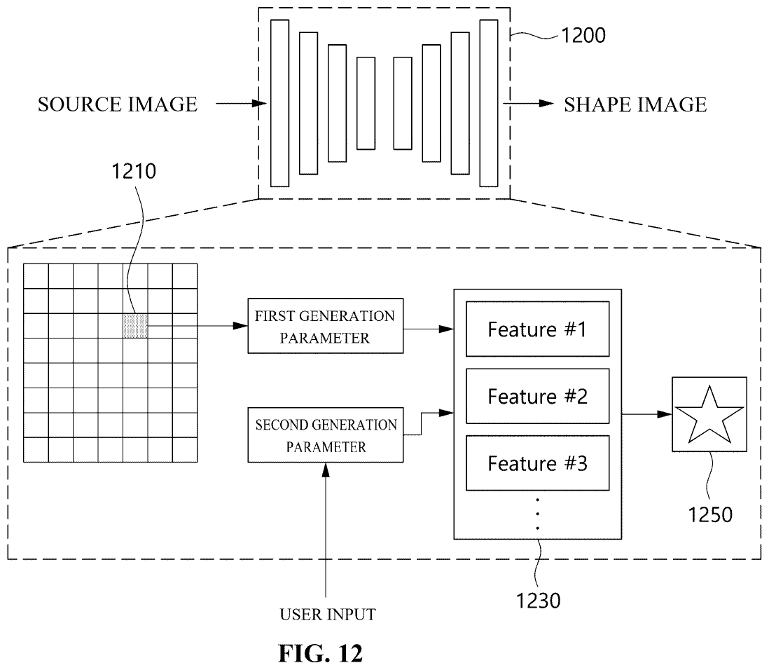

FIG. 12 is a diagram illustrating an example in which an electronic device generates a shape image using an image generation model, according to various embodiments.

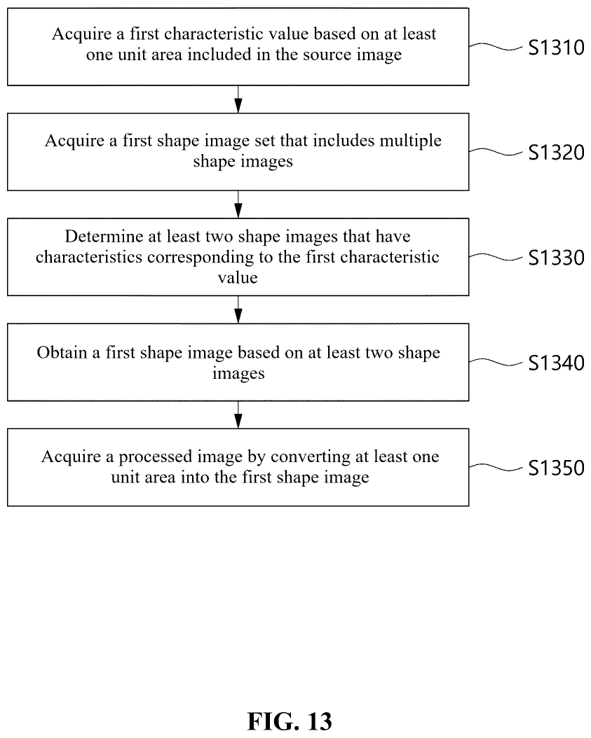

FIG. 13 is a flowchart illustrating an embodiment of a method in which an electronic device acquires multiple shape images corresponding to a unit area and obtains a processed image, according to various embodiments.

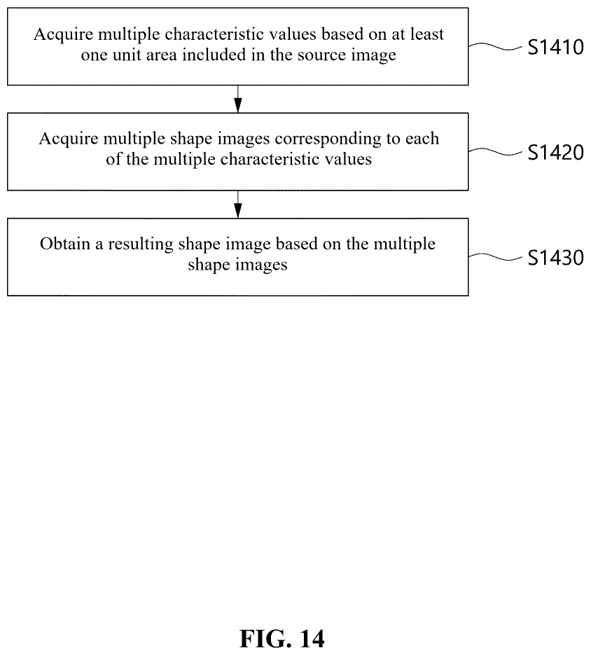

FIG. 14 is a flowchart illustrating another embodiment of a method in which an electronic device acquires multiple shape images corresponding to a unit area and obtains a processed image, according to various embodiments.

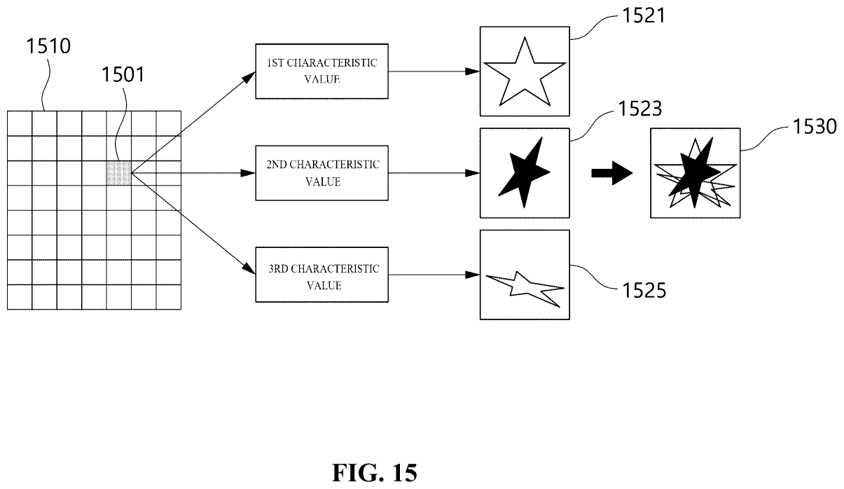

FIG. 15 is a diagram illustrating an example of a method by which an electronic device acquires multiple shape images corresponding to a unit area and obtains a processed image, according to various embodiments.

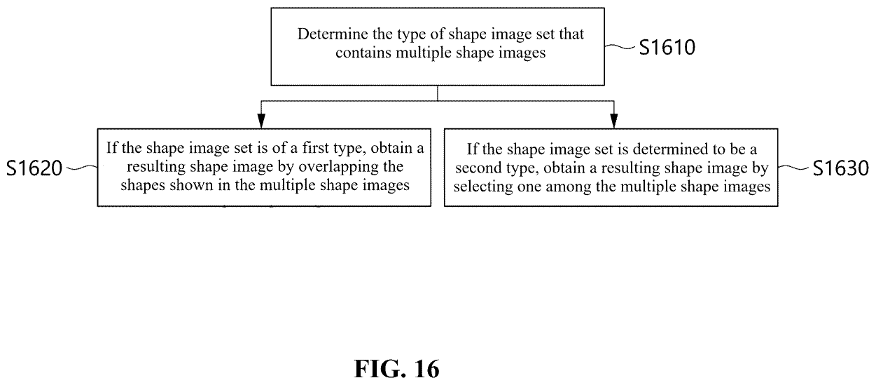

FIG. 16 is a flowchart illustrating how an electronic device may obtain a resulting shape image according to the type of shape image, according to various embodiments.

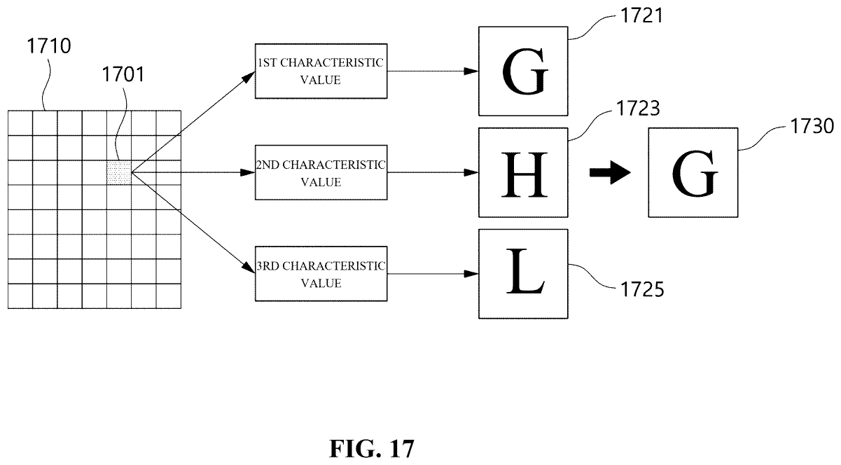

FIG. 17 is a diagram illustrating another example of how an electronic device acquires multiple shape images corresponding to a unit area and obtains a processed image, according to various embodiments.

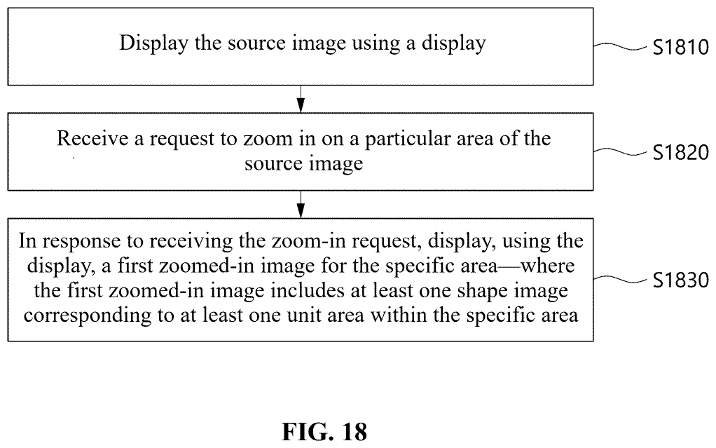

FIG. 18 is a flowchart illustrating a method of performing an image zooming operation by an electronic device in response to a zoom-in input for a source image, according to various embodiments.

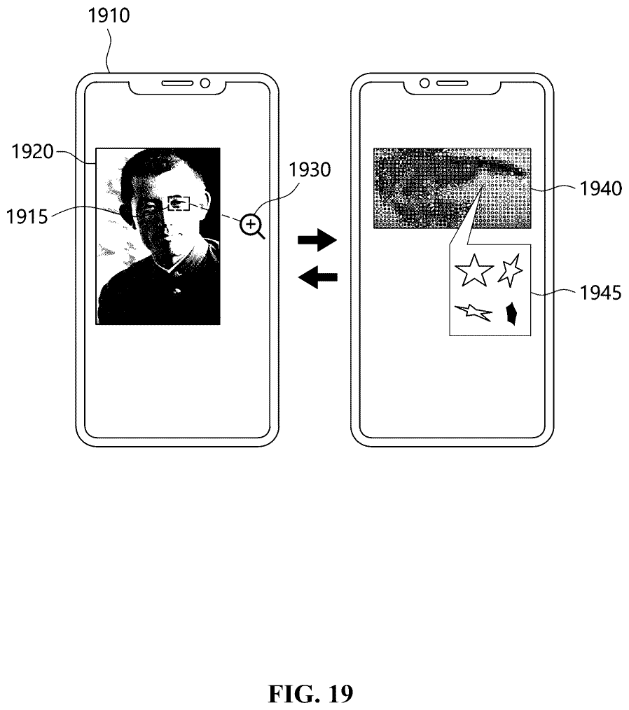

FIG. 19 is a diagram illustrating an example in which an electronic device performs an image zooming operation in response to a zoom-in input for a source image, according to various embodiments.

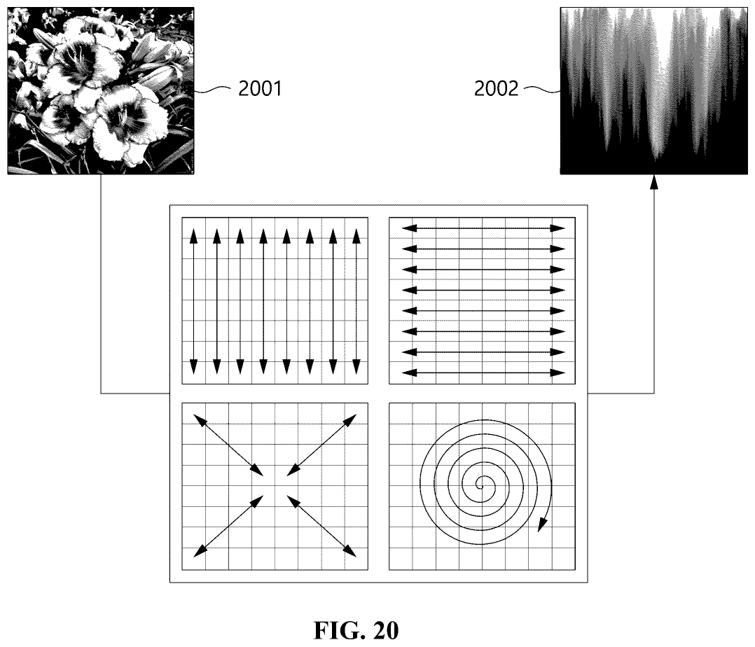

FIG. 20 is a diagram illustrating an example of how an electronic device processes an image according to pixel-based image processing, in accordance with various embodiments.

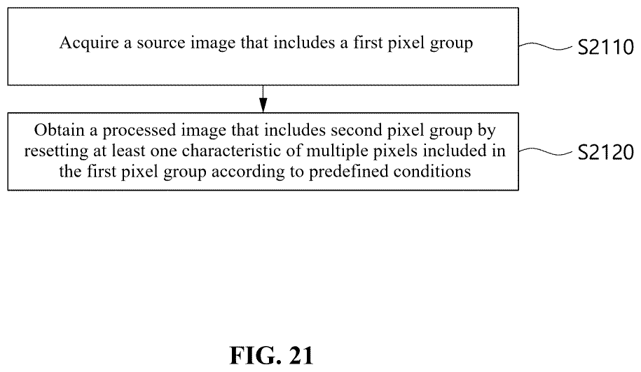

FIG. 21 is a flowchart illustrating a method by which an electronic device provides a pixel-based image processing function, according to various embodiments.

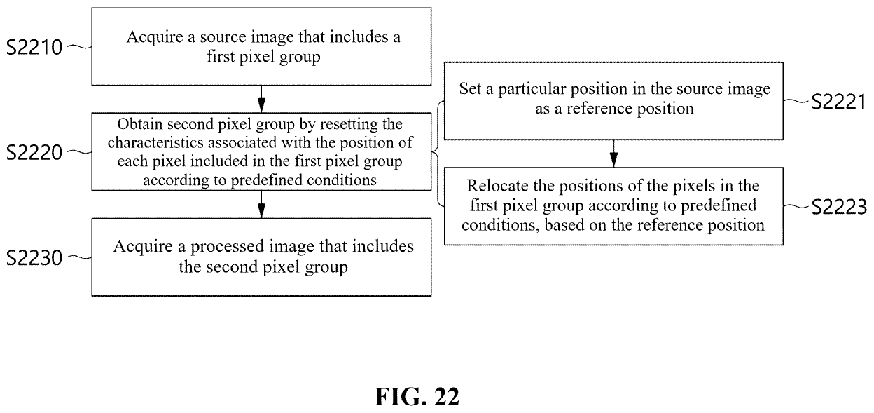

FIG. 22 is a flowchart illustrating one embodiment of a method in which an electronic device provides a pixel-based image processing function, according to various embodiments.

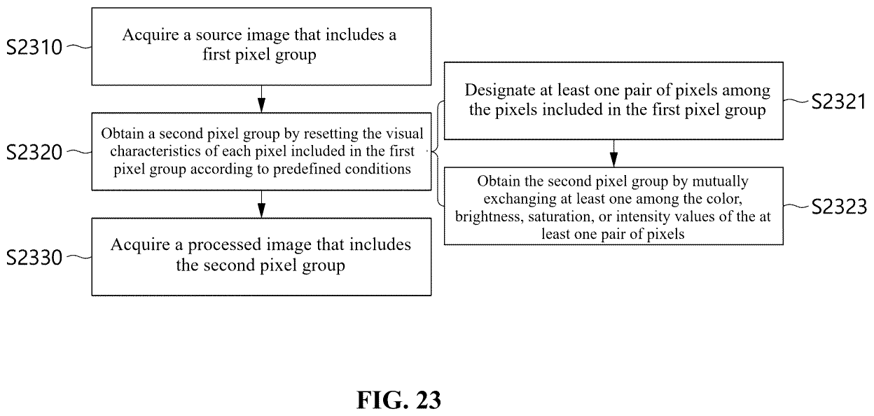

FIG. 23 is a flowchart illustrating another embodiment of a method in which an electronic device provides a pixel-based image processing function, according to various embodiments.

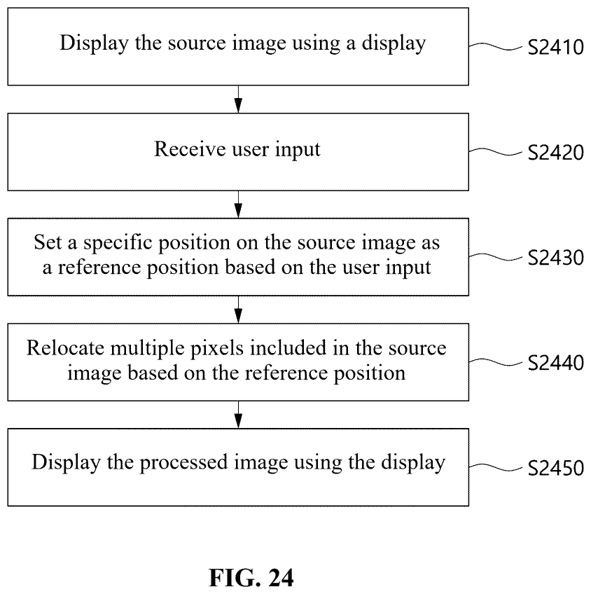

FIG. 24 is a flowchart illustrating one embodiment of a method in which an electronic device resets the characteristics of the pixels in an image based on user input, according to various embodiments.

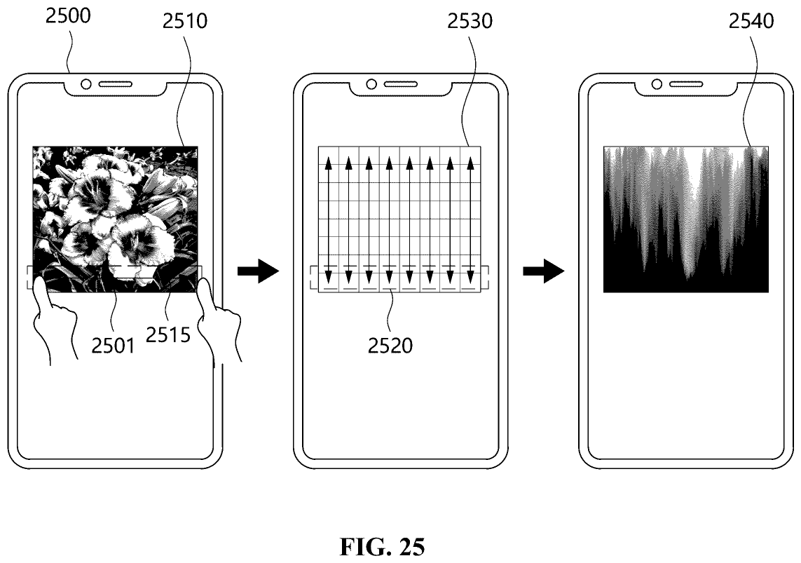

FIG. 25 is a diagram illustrating one example of how an electronic device resets the characteristics of the pixels in an image based on user input, according to various embodiments.

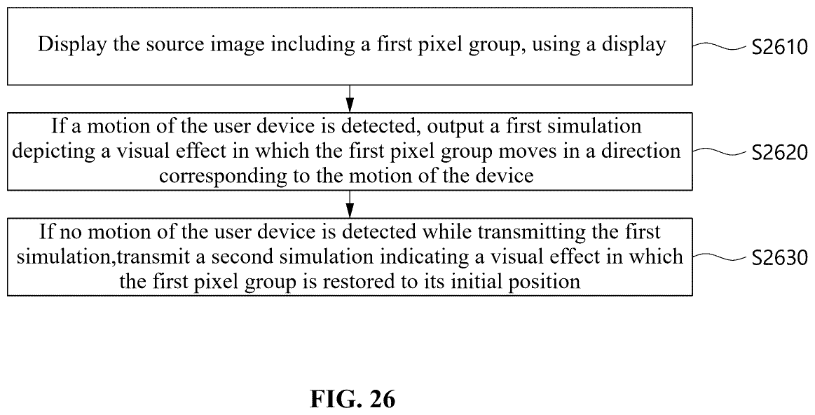

FIG. 26 is a flowchart illustrating another embodiment of a method in which an electronic device resets the characteristics of the pixels in an image based on user input, according to various embodiments.

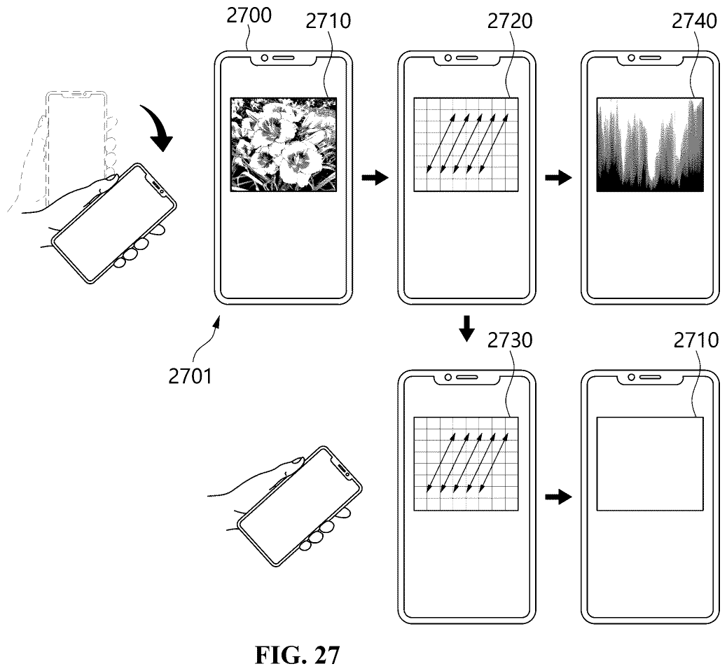

FIG. 27 is a diagram illustrating another example of how an electronic device resets the characteristics of the pixels in an image based on user input, according to various embodiments.

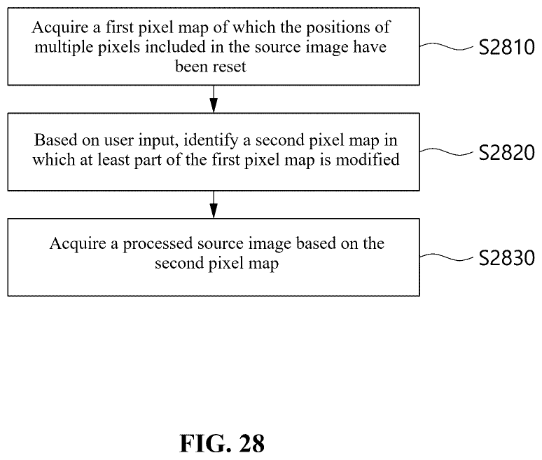

FIG. 28 is a flowchart illustrating a method of image transformation using a pixel map, according to various embodiments.

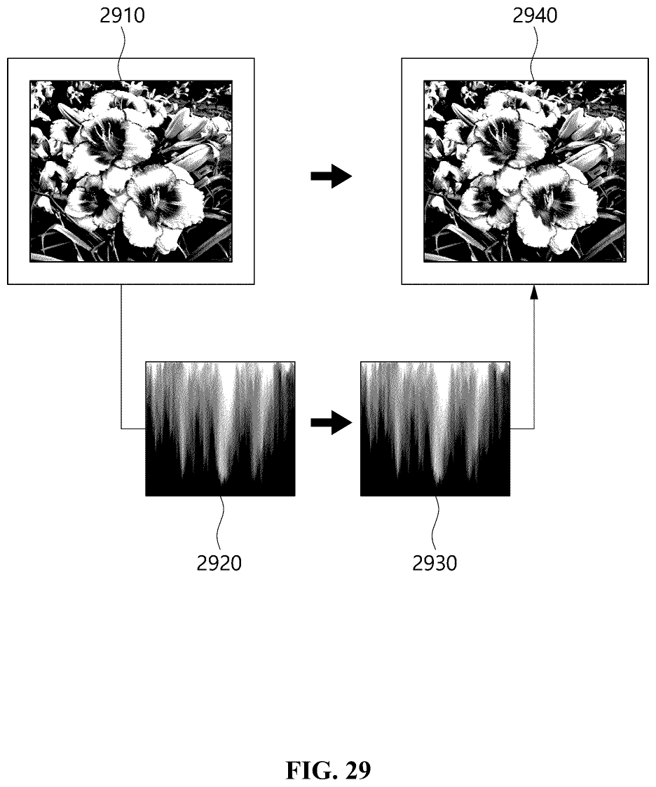

FIG. 29 is a diagram illustrating an example of an image transformation method using a pixel map, according to various embodiments.

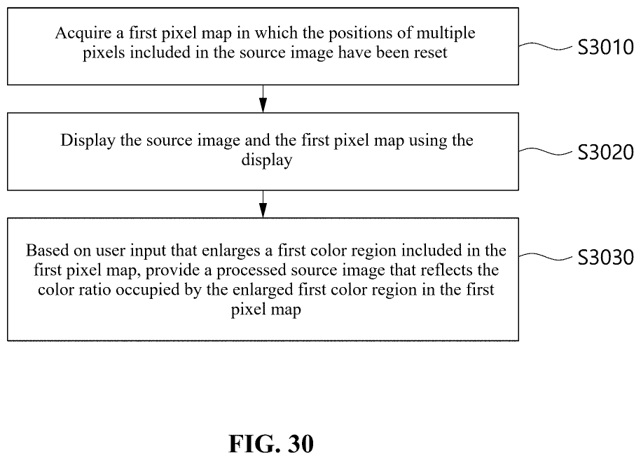

FIG. 30 is a flowchart illustrating an embodiment in which an electronic device transforms an image by reflecting changes in a pixel map identified based on user input, according to various embodiments.

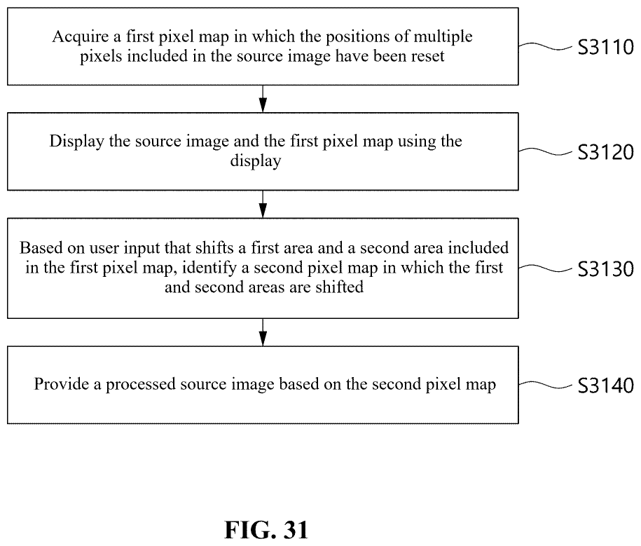

FIG. 31 is a flowchart illustrating another embodiment in which an electronic device transforms an image by reflecting changes in a pixel map identified based on user input, according to various embodiments.

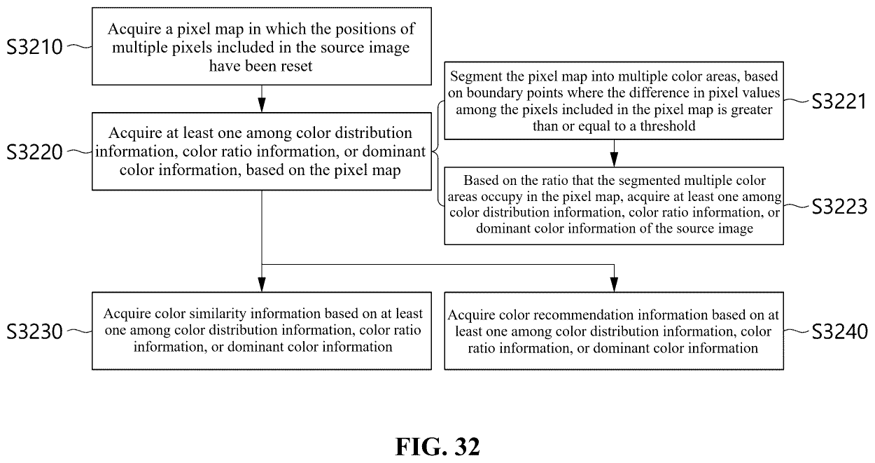

FIG. 32 is a diagram illustrating information that can be acquired based on a pixel map by an electronic device, according to various embodiments.

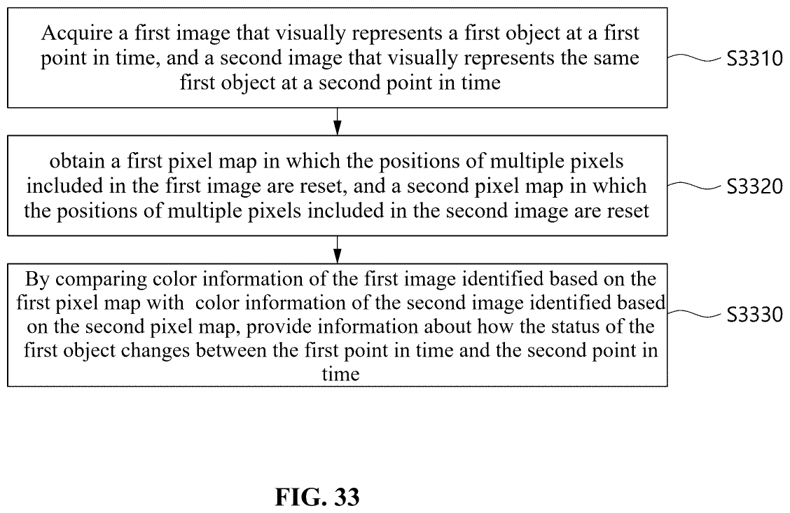

FIG. 33 is a flowchart illustrating another example of how an electronic device acquires information based on a pixel map, according to various embodiments.

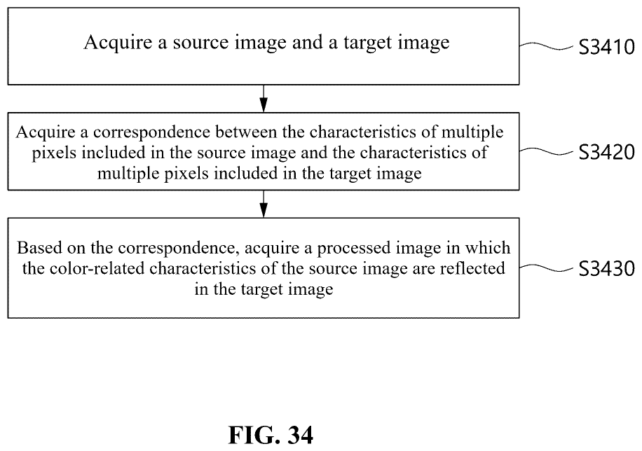

FIG. 34 is a flowchart illustrating a method for an electronic device to provide a pixel transition function, according to various embodiments.

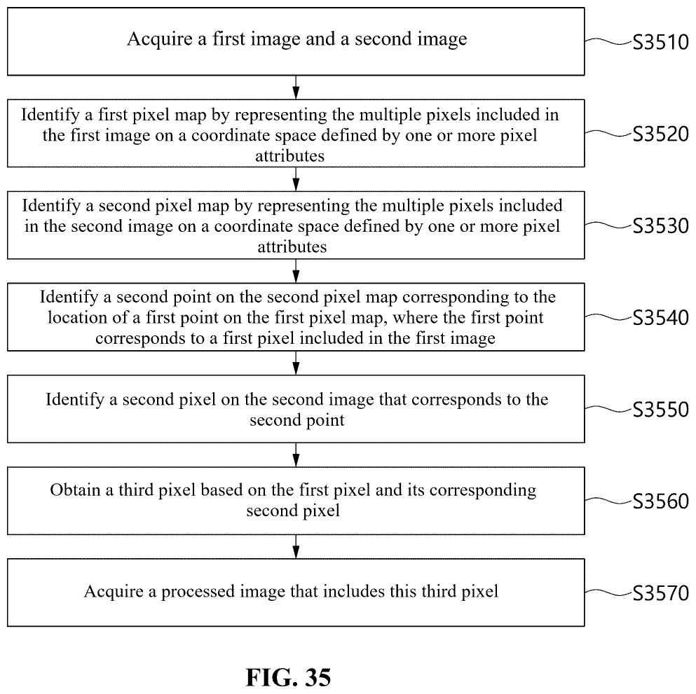

FIG. 35 is a flowchart illustrating a method for providing a pixel transition function based on the correspondence between images, according to various embodiments.

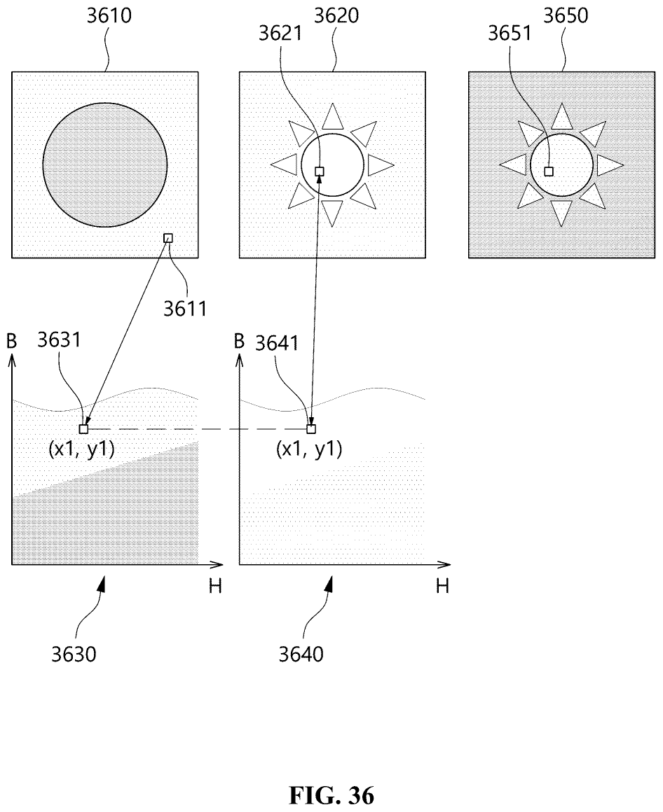

FIG. 36 is a diagram illustrating a concrete example in which an electronic device provides a pixel transition function between images based on their correspondence, according to various embodiments.

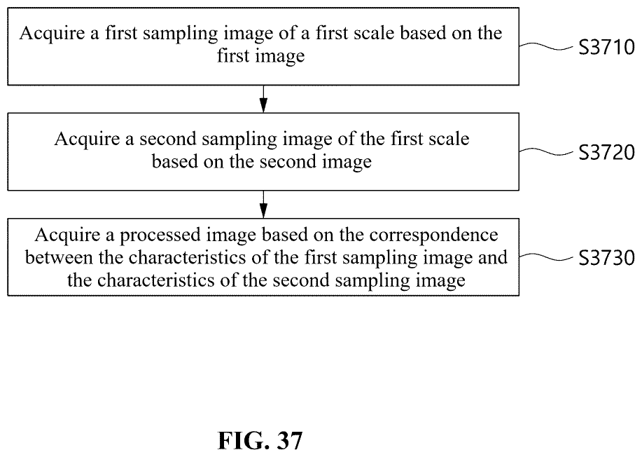

FIG. 37 is a flowchart illustrating one embodiment of a method by which an electronic device provides a pixel transition function between images of different scales, according to various embodiments.

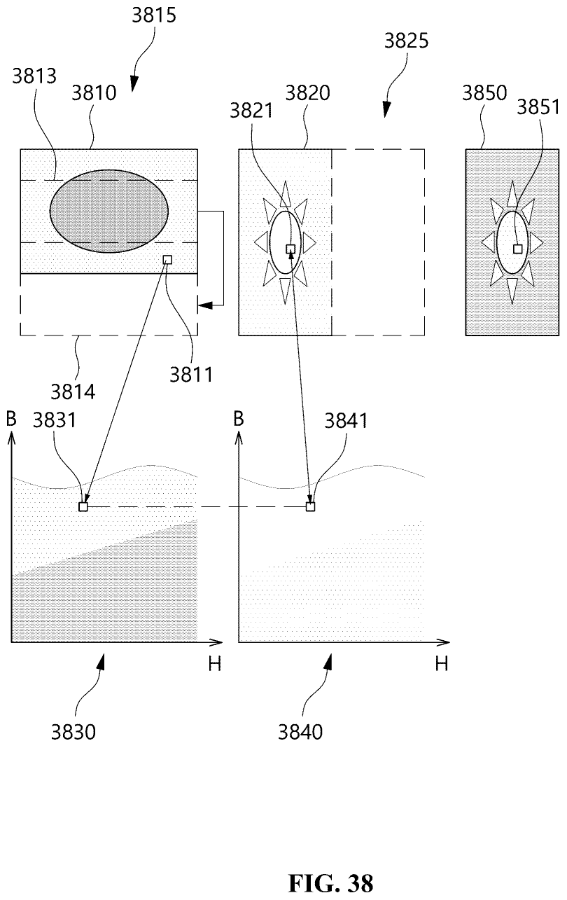

FIG. 38 is a diagram illustrating an example of one embodiment of how an electronic device provides a pixel transition function between images of different scales, according to various embodiments.

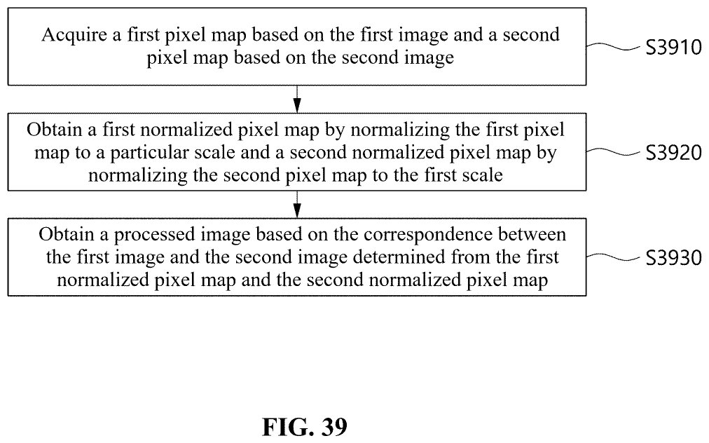

FIG. 39 is a flowchart illustrating another embodiment of a method in which an electronic device provides a pixel transition function between images of different scales, according to various embodiments.

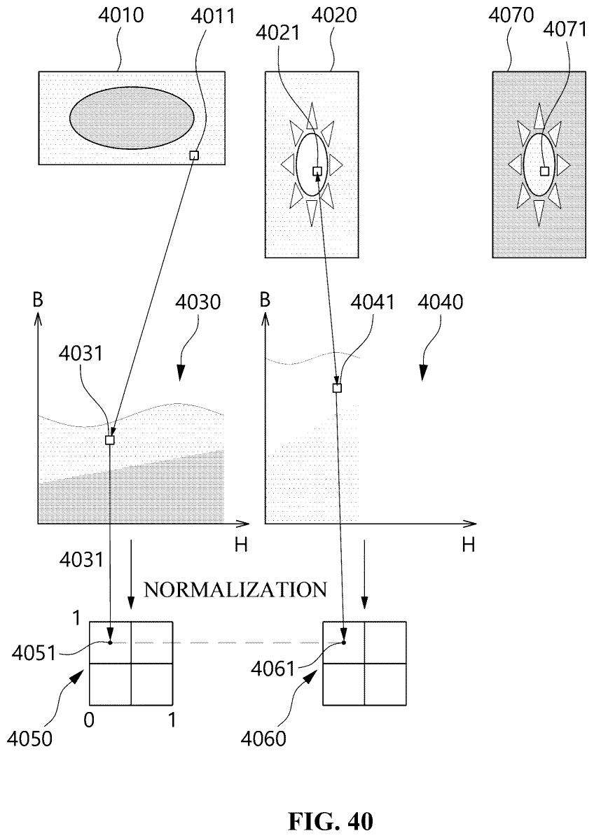

FIG. 40 is a diagram illustrating an example of another embodiment of how an electronic device provides a pixel transition function between images of different scales, according to various embodiments.

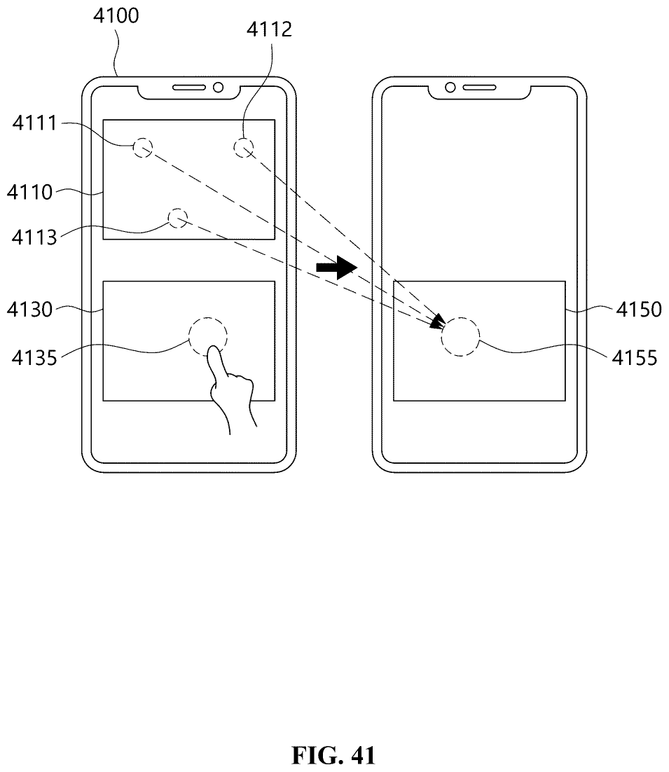

FIG. 41 is a diagram illustrating an embodiment in which an electronic device provides a pixel transition function based on user input, according to various embodiments.

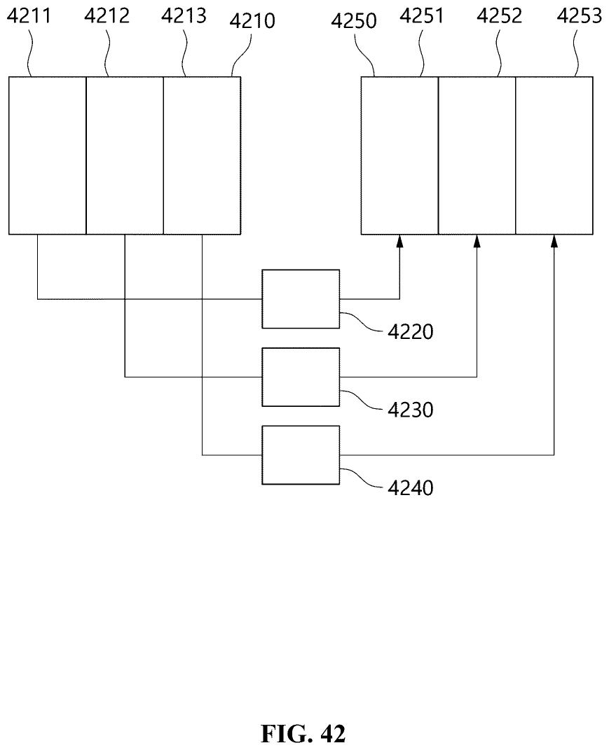

FIG. 42 is a diagram illustrating one embodiment of a method by which the electronic device processes a target image based on multiple images, according to various embodiments.

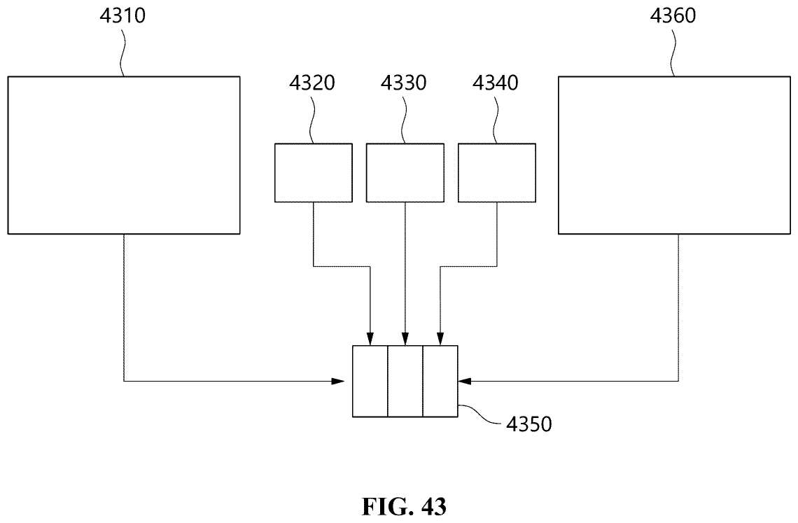

FIG. 43 is a diagram illustrating another embodiment of a method by which an electronic device processes a target image based on multiple images, according to various embodiments.

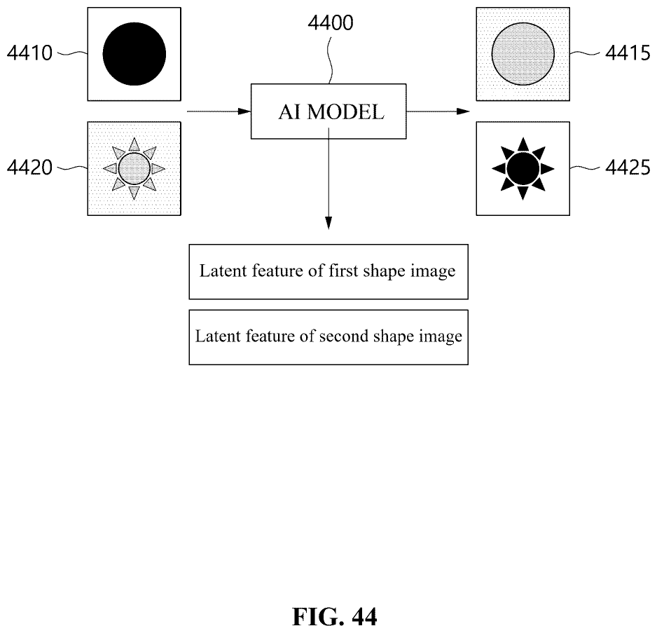

FIG. 44 is a diagram illustrating a method by which an electronic device performs a color transition between shape images using a deep learning model, according to various embodiments.

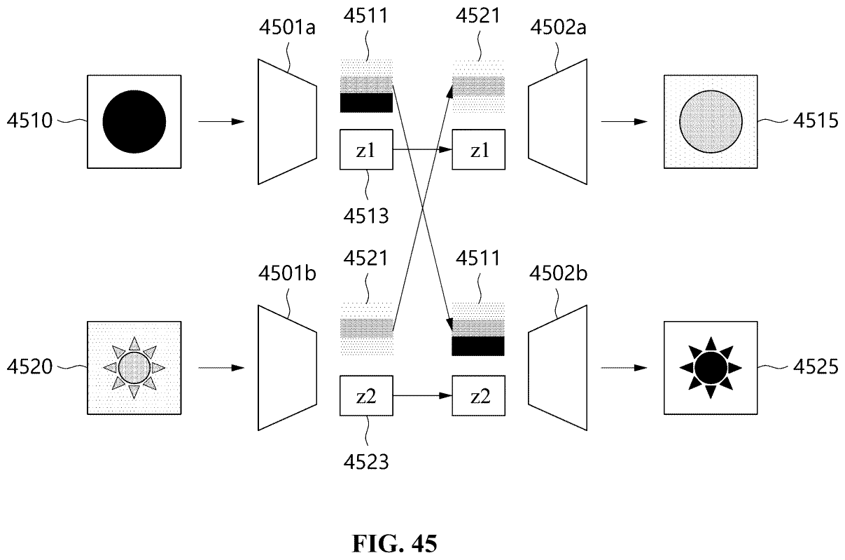

FIG. 45 is a diagram illustrating a method by which an electronic device creates a processed shape image by exchanging color characteristics between shape images via a deep learning model, according to various embodiments.

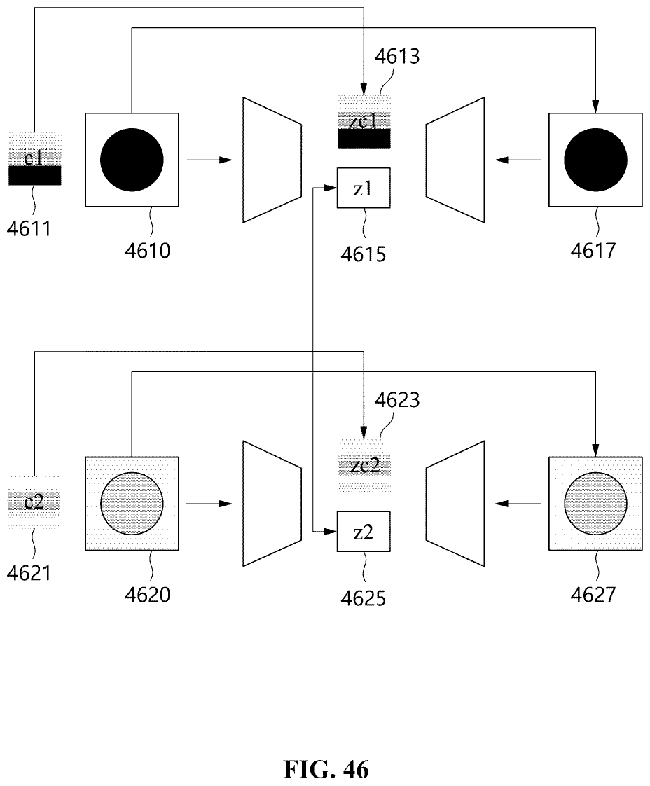

FIG. 46 is a diagram illustrating a training method for a deep learning model aimed at creating a processed shape image by exchanging color characteristics between shape images, according to various embodiments.

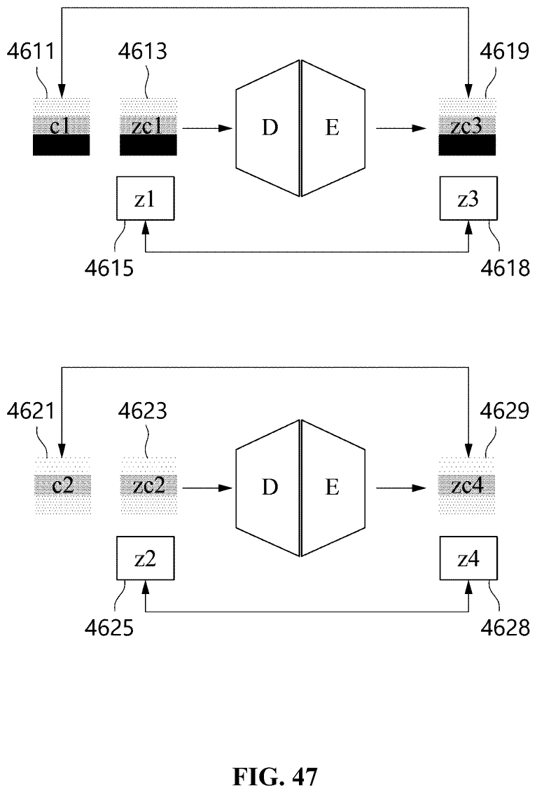

FIG. 47 is a diagram illustrating an additional training method for a deep learning model to generate a processed shape image by exchanging color characteristics between shape images, according to various embodiments.

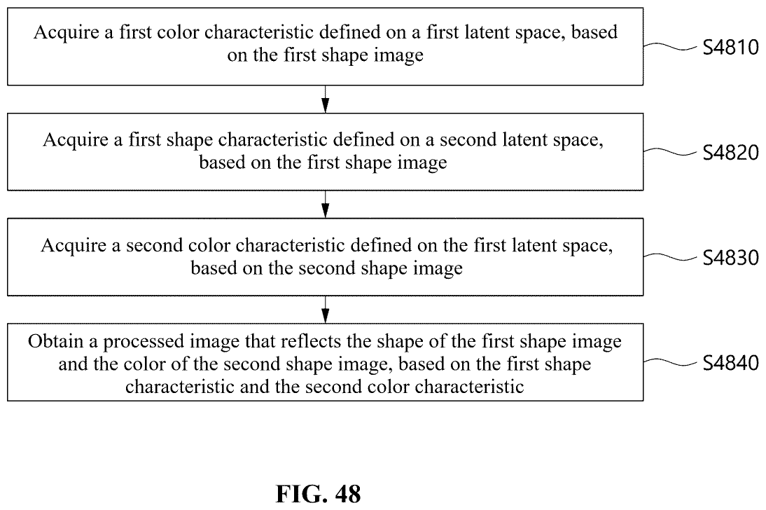

FIG. 48 is a flowchart illustrating a method by which an electronic device obtains a processed image by utilizing a color transition function among shape images, according to various embodiments.

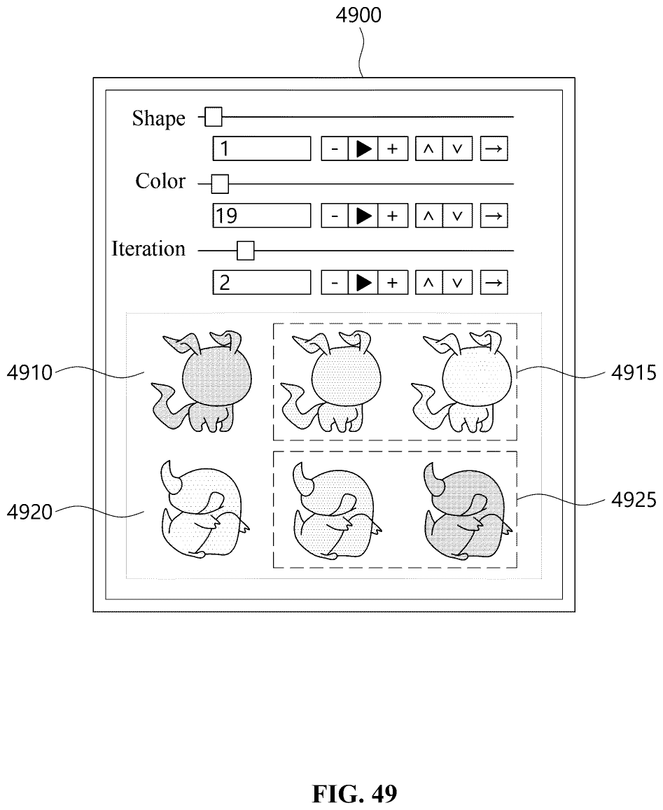

FIG. 49 is a diagram illustrating a method by which an electronic device performs a pixel transition operation based on user input and provides the outcome, according to various embodiments.

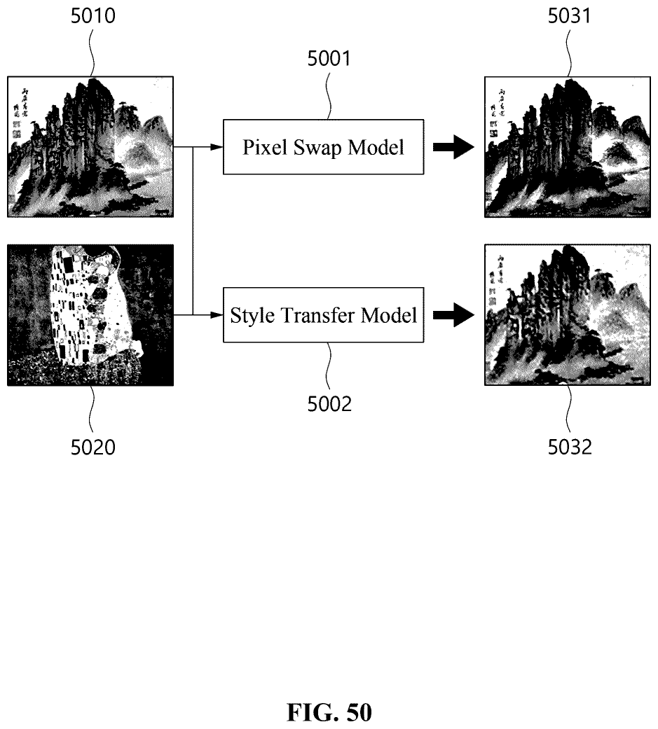

FIG. 50 is a diagram illustrating various methods by which an electronic device can utilize multiple images to obtain a processed image, according to various embodiments.

Hereinafter, the embodiments of the present disclosure will be described in detail with reference to the accompanying drawings. In describing the embodiments, technical details that are well-known to those skilled in the art and are not directly related to the present disclosure will be omitted. This is to clearly describe the subject matter of the present disclosure by omitting redundant descriptions.

### DETAILED DESCRIPTION OF THE INVENTION

### Modes of the Invention

The embodiments presented in this specification are intended to clearly describe the spirit of the present invention to those of ordinary skill in the relevant art. The present invention is not limited to the embodiments described herein, and the scope of the present invention should be interpreted to encompass modifications or variations that do not depart from its spirit of the present invention.

Although the terminology used in this specification includes as general terms currently widely accepted for describing the functions in the present invention, interpretations of these terms may vary depending on the intentions of practitioners in the relevant field, precedents, or emerging technologies. In a case where a specific term is defined and used with different meanings, the specific meaning will be explicitly provided. Therefore, the terms used herein should be interpreted based on the substantive meaning and the overall context of this specification rather than their mere literal meaning.

The accompanying drawings are intended to easily describe the present invention, and the shapes depicted in the drawings may be exaggerated as necessary to aid understanding of the present invention. Thus, the scope of the present invention is not limited by the depictions in the drawings.

In this specification, each of the phrases such as “A or B,” “at least one of A and B,” “at least one of A or B,” “A, B, or C,” “at least one of A, B, and C,” and “at least one of A, B, or C” may include any of the items enumerated in the corresponding phrase or all possible combinations thereof.

In cases where describing detailed configurations or functions known in relation to the present invention may make the subject matter ambiguous, such description will be omitted as necessary. Additionally, numerical designations (e.g., first, second) used in the description are merely symbols for differentiating one component from another component and do not imply a sequential or hierarchical order unless the context clearly indicates otherwise.

The suffixes “part,” “module,” and “unit” used for the components in this specification are provided for ease of writing and do not imply distinctive meaning, functions, or roles by themselves.

In other words, the embodiments of the disclosure are provided to make the disclosure complete and to give one of ordinary skill in the art to which the disclosure belongs a sense of the scope of the disclosure, and the invention of the disclosure is defined only by the scope of the claims. Throughout the specification, like reference numerals refer to like components.

The terms “first” and “second” may be used to describe various components, but these terms are only for differentiation purposes. The above terms are used only for the purpose of distinguishing one component from another, e.g. a first component may be named as a second component, and similarly a second component may be named as a first component, without departing from the scope of the rights according to the concepts of the present disclosure.

It should be understood that when an element is described as being “connected” or “coupled” to another element, there may be intervening elements in between or it may be directly connected or coupled to the other element. On the other hand, when an element is described as being “directly connected” or “directly coupled” to another element, it should be understood that there are no intervening elements. Other expressions that describe the relationship between elements (i.e., “between” and “immediately between”, “neighboring to” and “directly neighboring to”, or “adjacent to” and “directly adjacent to”) should be interpreted similarly.

In the drawings, each block of the flowcharts and combinations of the flowcharts may be performed by computer program instructions. Since these computer program instructions may be incorporated into a processor of a general-purpose computer, special purpose computer, or other programmable data processing apparatus, the instructions executed by the processor of the computer or other programmable data processing apparatus create means for performing the functions described in the flowchart block(s). Since these computer program instructions may be stored in a computer-usable or computer-readable memory that can direct a computer or other programmable data processing apparatus to implement a function in a particular manner, the instructions stored in the computer-usable or computer-readable memory can produce articles of manufacture that include instructions for means to perform the functions described in the flowchart block(s). Since the computer program instructions may be mounted on a computer or other programmable data processing apparatus, a series of operational steps may be performed on the computer or other programmable data processing apparatus to produce a computer-executed process, and the instructions for the computer or other programmable data processing apparatus may provide steps for performing the functions described in the flowchart block(s).

A machine-readable storage medium may also be provided in the form of a non-transitory storage medium. Here, “non-transitory” means that the storage medium is a tangible device and does not contain a signal (e.g. electromagnetic wave), and this term does not distinguish between a case where data is semi-permanently stored in the storage medium and a case where data is temporarily stored.

Each block may represent a module, segment, or portion of code including one or more executable instructions designed to perform a specified logical function. It should be noted that in some embodiments, the functions mentioned in the blocks may occur in a different order than described. For example, two blocks shown in succession may be performed concurrently, simultaneously or in reverse order, depending on the functions they represent. For example, operations performed by a module, program, or other component may be executed sequentially, in parallel, repeatedly, or heuristically; one or more of the operations may be executed in a different order, omitted, or one or more other operations may be added.

The term “unit” used in this specification refers to software or hardware components such as Field Programmable Gate Array (FPGA) or Application Specific Integrated Circuit (ASIC). The “unit” performs specific roles but is not limited to software or hardware. The “unit” may be configured to reside in an addressable storage medium or to reproduce one or more processors. Accordingly, in some embodiments, the “unit” includes components such as software components, object-oriented software components, class components, processes, functions, attributes, procedures, subroutines, segments of program code, drivers, firmware, microcode, circuits, data, databases, data structures, tables, arrays, and variables. The functions provided in the components and “units” may be combined into fewer components and “units,” or it may be disseminated into additional components and “units.” These components and “units” may be implemented to reproduce one or more CPUs within a device or a secure multimedia card. Additionally, according to various embodiments of the present disclosure, the “units” may include one or more processors.

According to an embodiment of the present disclosure, there may be provided an image processing method including: acquiring a source image by at least one processor operating based on at least some of a plurality of instructions stored in a memory; acquiring a first characteristic value based on at least one unit area included in the source image; and obtaining a first shape image by selecting, among a plurality of shape images included in a first shape image set stored in the memory, a shape image corresponding to the first characteristic value.

The first shape image set may include shape images grouped by a first type of shape.

The method may further include obtaining a processed image by converting at least one unit area into the first shape image.

The step of obtaining the first shape image may include: checking characteristics of at least one shape image included in the first shape image set stored in the memory; and acquiring the first shape image by selecting, based on the checked characteristics, a shape image corresponding to the first characteristic value.

The first characteristic value may include at least one among a color value, a brightness value, a saturation value, or an intensity value.

At least one unit area may be specified based on a user input for a particular region of the source image.

The method may further include accessing a database (DB) constructed in the memory to check the first shape image set.

The step of obtaining the first shape image may include: acquiring a first generation parameter based on the first characteristic value; generating a first shape image set including the first shape image using an image generation model, based on the first generation parameter; storing the first shape image set in the memory; and obtaining the first shape image by selecting, among a plurality of shape images included in the first shape image set, a shape image corresponding to the first characteristic value.

The method may further include: acquiring shape-related features based on the first generation parameter via the image generation model; and generating the first shape image set based on the shape-related features.

The shape-related features may include features dependent on the shape and features independent of the shape.

At least one processor may generate the first shape image set further taking into account a second generation parameter obtained based on user input.

The operation method of the at least one processor described above may further include: acquiring a second characteristic value based on the at least one unit area included in the source image; obtaining a second shape image by selecting, among a plurality of shape images included in the first shape image set stored in the memory, a shape image corresponding to the second characteristic value; obtaining a resultant shape image based on the first shape image and the second shape image; and acquiring a processed image by converting the at least one unit area into the resultant shape image.

If the first shape image set is associated with a first type of shape, the resultant shape image may be obtained so as to depict both the shape included in the first shape image and the shape included in the second shape image. If the first shape image set is associated with a second type of shape, the resultant shape image may be obtained so as to depict one among the shape included in the first shape image and the shape included in the second shape image.

There may be provided a computer-readable recording medium in which a program for executing the aforementioned method is recorded.

In addition, according to an embodiment of the present disclosure, there may be provided an electronic device for providing a processed image by processing a source image, the electronic device including: a memory in which a plurality of instructions are stored; and at least one processor operating based on at least some of the plurality of instructions, wherein the at least one processor is configured to acquire the source image, acquire a first characteristic value based on at least one unit area included in the source image, receive, based on user input, a first shape image set comprising a plurality of shape images, and obtain a first shape image by selecting, among the plurality of shape images, a shape image corresponding to the first characteristic value.

Furthermore, according to an embodiment of the present disclosure, there may be provided an electronic device for providing a pixel-based image processing method, the electronic device including: a display; and at least one processor, wherein the at least one processor is configured to display a source image using the display, set at least one region of the source image as a reference position, obtain a second pixel group by resetting a plurality of pixels included in a first pixel group of the source image based on the reference position, and display, using the display, a first processed image including the second pixel group.

The reference position may be set based on a first user input regarding a specific location corresponding to at least one region of the source image on the display.

At least one processor may be further configured to provide, through the display, a first simulation including a visual effect in which positions of a plurality of pixels included in the source image are rearranged.

At least one processor may acquire the second pixel group by identifying a plurality of characteristic values corresponding to the plurality of pixels included in the source image and adjusting at least some of those characteristic values based on the reference position.

At least one processor may obtain the second pixel group by rearranging positions of the plurality of pixels included in the first pixel group based on the reference position.

At least one processor may identify a plurality of characteristic values corresponding to the plurality of pixels included in the source image and obtain the second pixel group such that pixels having higher characteristic values are located nearer to the reference position.

A specific position connecting a first position and a second position on the display, which respectively correspond to a first region and a second region of the source image, may be set as the reference position based on a second user input regarding the first and second positions.

If the motion of the electronic device is detected using at least one sensor included therein, the at least one processor may be further configured to provide, via the display, a second simulation including a visual effect in which positions of a plurality of pixels included in the second pixel group of the first processed image are rearranged according to the detected motion's direction.

The at least one processor may be further configured to display the first processed image using the display if the motion of the electronic device ceases.

A distribution of color-related characteristics of the plurality of pixels included in the second pixel group may correspond to a distribution of color-related characteristics of the plurality of pixels included in the first pixel group.

The first processed image may be provided as a pixel map in which a plurality of pixels included in the source image are arranged based on their characteristics, and the at least one processor may be further configured to obtain a second processed image by adjusting at least some of the plurality of pixels included in the source image, based on a third user input with respect to the first processed image.

If the color distribution of the first processed image is changed by the third user input, the second processed image may be acquired so as to reflect the changed color distribution.

The first processed image may be provided as a pixel map in which a plurality of pixels included in the source image are arranged based on their characteristics, and the at least one processor may be further configured to acquire at least one among color distribution information, color ratio information, or dominant color information based on the first processed image.

At least one processor may be further configured to obtain color similarity information based on at least one among the color distribution information, color ratio information, or dominant color information.

At least one processor may be further configured to obtain color recommendation information based on at least one among the color distribution information, color ratio information, or dominant color information.

In addition, according to an embodiment of the present disclosure, in an image processing method, at least one processor operating in accordance with at least some of a plurality of instructions stored in a memory may: acquire a first image and a second image; acquire a first pixel map by displaying a plurality of pixels included in the first image in a coordinate space defined by one or more pixel attributes, and acquire a second pixel map by displaying a plurality of pixels included in the second image in the coordinate space defined by the one or more pixel attributes; and obtain a third image, which reflects a first characteristic of the first image and a second characteristic of the second image, based on a positional correspondence between the first pixel map and the second pixel map.

The coordinate space defined by the one or more pixel attributes may be a two-dimensional coordinate space defined based on a first attribute related to the color of the pixel and a second attribute related to the brightness of the pixel.

The first characteristic may include an attribute associated with position, and the second characteristic may include an attribute associated with color.

The step of obtaining the third image may include: determining a second point on the second pixel map that corresponds to the position of a first point on the first pixel map, the first point corresponding to a first pixel included in the first image; identifying a second pixel in the second image that corresponds to the second point; and obtaining a third image that includes a third pixel reflecting a first characteristic of the first pixel and a second characteristic of the second pixel.

The method may further include acquiring a first sampling image of a first scale based on the first image, and acquiring a second sampling image of the first scale based on the second image, wherein the first pixel map corresponds to at least a portion of the first sampling image, and the second pixel map corresponds to at least a portion of the second sampling image.

The method may further include acquiring a first normalized pixel map by normalizing the first pixel map to a third scale and acquiring a second normalized pixel map by normalizing the second pixel map to the first scale, and may establish a positional correspondence between the first pixel map and the second pixel map based on a positional correspondence between the first normalized pixel map and the second normalized pixel map.

In addition, according to an embodiment of the present disclosure, there may be provided an electronic device for providing a processed image based on multiple images, the electronic device including: a display; a memory in which multiple instructions are stored; and at least one processor operating based on some of the multiple instructions, wherein the at least one processor is configured to display the first image and the second image using the display, acquire a first pixel map by plotting a plurality of pixels included in the first image in a coordinate space defined by one or more pixel attributes, acquire a second pixel map by plotting a plurality of pixels included in the second image in the same coordinate space, and display, via the display, a processed image that reflects a first characteristic of the first image and a second characteristic of the second image based on a positional correspondence between the first and second pixel maps.

At least one processor may be further configured to receive, through the display, a user input regarding a specific area of the processed image, and to visually present a first region of the first image and the second image corresponding to the specific area.

At least one processor may be further configured to receive, via the display, a user input regarding a third region of the second image, identify at least one region on the first image corresponding to that third region, and adjust at least one pixel's characteristics included in the at least one region of the first image based on characteristics of at least one pixel included in the third region of the second image.

At least one processor may be further configured to provide, via the display, a first simulation that includes a visual effect in which the first image is transformed into the third image.

The operating principles of the present disclosure will be described in detail with reference to the accompanying drawings. In describing the present disclosure, detailed descriptions of known functions or configurations related to the present disclosure will be omitted when it may make the subject matter of the present disclosure unnecessarily obscure. The terms to be defined in consideration of functions in this disclosure are defined in terms of users or operators intentions or customs. Therefore, the definition should be based on the contents throughout this specification.

FIG. 1A is a diagram illustrating an embodiment of an image processing system according to various embodiments.

Referring to FIG. 1A, an electronic device 100a according to one embodiment may execute an image processing program 101a using a processor 110a (e.g., an AP such as a CPU or GPU) to perform an image processing procedure. In this case, the electronic device 100a may be any stand-alone computing platform such as a desktop or workstation computer, a laptop computer, a tablet computer, a smartphone or PDA, a game console, a set-top box, or another suitable computing platform.

FIG. 1B is a diagram illustrating an embodiment of an image processing system according to various embodiments.

Referring to FIG. 1B, an electronic device 100b according to one embodiment may be deployed together in a cloud environment, a data center, or a local area network (LAN), and so on. A client 13 may interact with the electronic device 100b via a network. In particular, the client 13 may transmit requests and receive responses through API calls received from an API server 11, which are delivered via the network and the network interface 12.us embodiments.

It will be understood that the network may include any type of public or private network, including the Internet or a LAN. It will be readily understood that the network may include any type of public and/or private network, such as the Internet, a LAN, a WAN, or any combination thereof. In this case, the electronic device 100b is a server computer, and the client 13 may be any typical personal computing platform.

FIG. 2 is a diagram illustrating the configuration of an electronic device that performs an image processing procedure according to various embodiments.

Referring to FIG. 2, an electronic device 100 according to one embodiment may include a processor 110, a communication circuit 120, a memory 130, and a display 140. It should be understood that the configuration of the electronic device 100 is not limited to what is shown in FIG. 2 or the above description, and it may further include hardware or software configurations typically found in general computing devices or mobile devices.

The processor 110 may include at least one processor, at least some of which is configured to provide different functions. For example, by executing software (e.g., a program), the processor 110 may control at least one other component (e.g., a hardware or software component) of the electronic device 100 connected to the processor 110, and may perform various data processing or operations. According to one embodiment, as at least part of such data processing or operations, the processor 110 may store commands or data received from other components in the memory 130 (e.g., volatile memory), process the commands or data stored in the volatile memory, and store the resulting data in non-volatile memory. According to one embodiment, the processor 110 may include a main processor (e.g., a central processing unit or an application processor) or an auxiliary processor (e.g., a graphics processing unit, a neural processing unit (NPU), an image signal processor, a sensor hub processor, or a communication processor) that can operate independently of or in conjunction with the main processor. For example, if the electronic device 100 includes a main processor and an auxiliary processor, the auxiliary processor may use less power than the main processor or be specialized in certain designated functions. The auxiliary processor may be implemented separately from the main processor, or as part of it. For instance, while the main processor is inactive (e.g., in a sleep state), the auxiliary processor may control, in place of the main processor, at least some of the functions or states related to at least one component of the electronic device 100, or it may control those functions or states together with the main processor while the main processor is active (e.g., application execution). According to one embodiment, the auxiliary processor (e.g., an image signal processor or a communication processor) may be implemented as part of another functionally related component (e.g., the communication circuit 120). According to another embodiment, the auxiliary processor (e.g., a neural processing unit) may include a hardware architecture specialized for processing an artificial intelligence (AI) model. The AI model may be generated through machine learning. Such learning may be performed, for example, on the electronic device 100 itself, in which the AI model is executed, or via a separate server. The learning algorithm may include supervised learning, unsupervised learning, semi-supervised learning, or reinforcement learning, but is not limited thereto. The AI model may include multiple layers of an artificial neural network. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or any combination of two or more of the foregoing, but is not limited thereto. In addition to or instead of a hardware architecture, the AI model may include a software architecture. Meanwhile, the operations of the electronic device 100 described below may be understood as operations of the processor 110.

According to various embodiments, the communication circuit 120 may support the establishment of a direct (e.g., wired) communication channel or a wireless communication channel between the electronic device 100 and an external electronic device (e.g., the server 10 or a client device in FIG. 1A), as well as communication through the established communication channel. The communication circuit 120 may operate independently of the processor 110 (e.g., an application processor) and may include one or more communication processors that support direct (e.g., wired) or wireless communication. According to one embodiment, the communication circuit 120 may include a wireless communication module (e.g., a cellular communication module, a short-range wireless communication module, or a global navigation satellite system (GNSS) communication module) or a wired communication module (e.g., a local area network (LAN) communication module or a power line communication module). Among these communication modules, the applicable module can communicate with an external electronic device (e.g., the server 10) via a first network (e.g., a short-range communication network such as Bluetooth, Wi-Fi Direct, or IrDA (infrared data association)) or a second network (e.g., a wide-area communication network such as a legacy cellular network, a 5G network, next-generation communication network, the Internet, or a computer network such as a LAN or WAN). These various types of communication modules may be integrated into a single component (e.g., a single chip), or implemented as multiple separate components (e.g., multiple chips). The wireless communication module may verify or authenticate the electronic device 100 within a communication network, such as the first or second network, using subscriber information (e.g., an International Mobile Subscriber Identity (IMSI)) stored in a subscriber identity module. The wireless communication module may support 5G networks and next-generation communication technologies, for example, NR (New Radio) access technology, in addition to 4G networks. NR access technology can support high-speed transmission of large-capacity data (eMBB: enhanced mobile broadband), minimized terminal power consumption and access by numerous terminals (mMTC: massive machine type communications), or high reliability and low latency (URLLC: ultra-reliable and low-latency communications). For instance, in order to achieve higher data transmission rates, the wireless communication module may support high-frequency bands (e.g., mm Wave bands). The wireless communication module may support various technologies to ensure performance in high-frequency bands, such as beamforming, massive MIMO (multiple-input and multiple-output), full dimensional MIMO (FD-MIMO), array antennas, analog beam-forming, or large-scale antennas. It may also support various requirements defined by the electronic device 100, external electronic devices (e.g., the server 10), or network systems. According to one embodiment, the wireless communication module may support a peak data rate for eMBB (e.g., 20 Gbps or higher), a loss coverage for mMTC (e.g., 164 dB or less), or a U-plane latency for URLLC (e.g., 0.5 ms or less in both downlink (DL) and uplink (UL), or 1 ms or less for round-trip communication).

According to various embodiments, the memory 130 may store various data used by at least one component (e.g., the processor 110) of the electronic device 100. For example, the data may include software (e.g., programs), as well as input or output data for commands related to such software. The memory 130 may include volatile or non-volatile memory. The memory 130 may be configured to store an operating system, middleware, applications, and/or the aforementioned AI model.

In addition, the memory 130 may include a database (DB) 135 that is constructed in a specific manner. Specifically, the DB 135 may be configured to pre-store various shape images. The processor 110 may access the DB 135 when necessary to retrieve image data that meets certain conditions or to store image data processed according to the image processing procedure into the DB 135.

According to various embodiments, the display 140 may provide information visually and/or audibly to the exterior of the electronic device 100 (e.g., to a user). For example, the display 140 may include various types of display devices (such as a monitor device, a hologram device, or a projector, and a control circuit for controlling such devices). According to one embodiment, the display may include a touch sensor configured to detect touch input or a pressure sensor configured to measure the force exerted by such touch.

Hereinafter, an image processing procedure according to various embodiments performed by the electronic device will be described.

FIG. 3 is a diagram illustrating an image processing procedure of an image processing device according to various embodiments. Here, the image processing device 100 may refer to the electronic device shown in FIGS. 1 and 2.

Referring to FIG. 3, the image processing device 300 may acquire a source image 301, and obtain a processed image 302 by processing the source image 301 in a predetermined manner. Here, the term “source image 301” may refer to the image that is input into the image processing procedure. Specifically, the source image 301 may be the image initially input by the user, but it is not limited to this; rather, the term is used to refer to any image input for the purpose of performing the image processing procedure. Additionally, the term “processed image 302” may refer to the image output according to the image processing procedure, and is used to refer to any image output by performing the image processing procedure.

### [Shape Image-Based Image Processing Method]

FIG. 4 is a flowchart illustrating a shape image-based image processing method according to various embodiments.

Referring to FIG. 4, an electronic device (or at least one processor of the electronic device) may acquire a source image S410. In this case, the electronic device may acquire the source image by receiving it from a user. Specifically, if the image is input (e.g., uploaded) to a portion of the memory from a client device, the electronic device may obtain the source image by retrieving that image.

Based on the source image, the electronic device may acquire a processed image composed of at least one shape image corresponding to at least one unit area included in the source image S420. Details regarding the unit area defined in this disclosure and the corresponding shape image will be described in detail with reference to FIG. 5.

FIG. 5 is a diagram illustrating a shape image corresponding to a unit area of a source image according to various embodiments.

Referring to FIG. 5, the source image 510 may include a plurality of pixels 501. Here, the pixel 501 may represent the smallest unit that constitutes an image. In general, a pixel has a rectangular shape, and the number of pixels represents the resolution; a larger number of pixels indicates a higher-resolution image.

In addition, the shape image 520 may be an image that depicts various shapes. For example, the shape image 520 may include an image of a geometric shape such as a star, an image of a semantic shape such as a particular font style, or an image of an abstract shape. Moreover, the shape image 520 may be pre-stored in the electronic device's database or may be generated by an image generation process performed by the electronic device (e.g., an image generated using a generative model).

Furthermore, the source image 510 may include a plurality of unit areas 502. Here, the term “unit area 502” is defined in this disclosure for the sake of explanation and may refer to an area in the source image that is replaced (or transformed) into a shape image. For example, a unit area 502 may be a specific area on the image made up of a single pixel or multiple pixels. In other words, the unit area 502 may be a software-selected region of interest intended for conversion into a shape image. Specifically, based on the source image 510, the electronic device may identify a shape image 520 corresponding to at least one unit area 502 included in the source image 510, and acquire a processed image 530 by replacing or converting the unit area 502 with the shape image 520.

FIG. 6 is a flowchart illustrating a method for converting a unit area of a source image into a shape image by an electronic device according to various embodiments.

Referring to FIG. 6, the electronic device may acquire at least one characteristic value based on at least one unit area included in the source image S610. Here, the characteristic value may represent a property of the image in numerical form. For example, at least one characteristic value may be a value indicating at least one of the colors (e.g., RGB/Hue), intensity (e.g., Grayscale), saturation, brightness, or luminance of the pixels included in the unit area, but is not limited thereto.

In addition, based on at least one characteristic value, the electronic device may acquire a first shape image corresponding to the at least one characteristic value S620. Specifically, the electronic device may retrieve or generate a shape image corresponding to the acquired characteristic value(s) from a database to obtain the first shape image. A detailed method of acquiring a shape image corresponding to the characteristic of the unit area will be described with reference to FIG. 7.

FIG. 7 is a flowchart illustrating an embodiment of a method by which an electronic device acquires a shape image corresponding to a unit area and obtains a processed image, according to various embodiments.

FIG. 8 is a diagram illustrating information related to shape images and the characteristics of those shape images stored in the database of an electronic device, according to various embodiments.

Referring to FIG. 7, the electronic device may acquire a first characteristic value based on at least one unit area included in the source image S710. A detailed explanation of step S710 may be omitted here since it is identical to the technical content of step S610 described above.

In addition, based on the first shape image set stored in the database, the electronic device may obtain a first shape image by selecting a shape image that corresponds to the first characteristic value S720.

The electronic device may store multiple sets of shape images in the database in advance. In this context, a shape image set may refer to a group of shape images stored together that are of the same shape type.

For example, referring to FIG. 8, the electronic device or its database 800 may store information 810 related to shape images and information 850 related to the characteristics of shape images. Specifically, the electronic device may store information 810 related to shape images, which includes a first shape image set 811 and a second shape image set 813. In this scenario, the first shape image set 811 may include shape images that depict a first type of shape (e.g., a star pattern), and the second shape image set 813 may include shape images that depict a second type of shape (e.g., a Korean-character pattern).

Furthermore, the electronic device may store information 850 related to the characteristics of shape images, including the characteristics 851 of the first shape image set and the characteristics 853 of the second shape image set. In this scenario, the characteristics 851 of the first shape image set may represent the characteristic values of multiple shape images included in the first shape image set 811. Specifically, the characteristics 851 of the first shape image set may include a first characteristic distribution 851a indicating the distribution of each characteristic value (Pi) of the N shape images in the first shape image set 811, but are not limited thereto. For example, the characteristics 851 of the first shape image set may include a first color distribution showing the distribution of color values of the N shape images in the first shape image set 811.

Returning to FIG. 7, the operation of the electronic device to acquire a shape image in step S720 may further include the following detailed operations:

The electronic device may identify the characteristics of at least one shape image included in the first shape image set stored in the database S721.

For example, referring to FIG. 8, the electronic device may confirm the characteristics 851 of the first shape image set. Specifically, the electronic device may identify the characteristic values of the plurality of shape images included in the first shape image set 811.

Referring again to FIG. 7, the electronic device may obtain the first shape image by determining a shape image whose characteristic matches the first characteristic value S723. Specifically, the electronic device may obtain the first shape image by selecting a shape image having the same or similar characteristic value as the first characteristic value corresponding to the unit area of the source image.

For example, referring to FIG. 8, the electronic device may obtain the first shape image 801 by selecting the shape image whose characteristic value matches the first characteristic value, based on the first characteristic distribution 851a.

Referring again to FIG. 7, the electronic device may acquire a processed image by converting at least one unit area of the source image into the first shape image S730. For example, the electronic device may acquire the processed image by converting the first unit area of the source image into a first shape image and converting a second unit area into a second shape image. In this case, the first shape image and the second shape image may each have characteristics corresponding to the characteristics of the first and second unit areas, respectively.

FIG. 9 is a diagram illustrating an example of a processed image acquired by the electronic device according to various embodiments.

Referring to FIG. 9, the processed image 810 acquired by the electronic device according to the operations in FIG. 7 may include a plurality of shape images. Specifically, a first area 815 of the processed image may contain multiple shape images. In this case, the first area 815 of the processed image may correspond to a unit area of the source image. That is, as the unit area of the source image is converted into multiple shape images, the first area 815 of the processed image may be implemented to include multiple shape images 820. In addition, these multiple shape images 820 may be configured to correspond to each of the plurality of pixels included in the first area 815 of the processed image. For example, the electronic device may acquire the processed image 810 such that a first pixel 821 in the first area 815 corresponds to a first shape image 830, but the disclosure is not limited thereto.

Even if the electronic device identifies at least one pixel characteristic (such as color (e.g., RGB/Hue), intensity (e.g., Grayscale), saturation, brightness, or luminance) within a specific area (unit area) of the source image and converts that specific area into a shape image having corresponding characteristics, the overall form of the image can still be preserved. As a result, when the user zooms in or out on the pixels of the source image, the shape image-based image processing procedure can offer a new user experience.

FIG. 10 is a flowchart illustrating another embodiment of a method in which an electronic device acquires a shape image corresponding to a unit area and obtains a processed image, according to various embodiments.

Referring to FIG. 10, the electronic device may acquire a first characteristic value based on at least one unit area included in the source image S1010. A detailed explanation of step S1010 is omitted here as it is the same as the technical content of step S710 described above.

Additionally, the electronic device may receive a first shape image set that includes a plurality of shape images from a user S1020. Specifically, to replace the at least one unit area of the source image with a given shape image, the electronic device may receive a shape image set from the user.

At this time, the electronic device may obtain first characteristic information corresponding to a plurality of shape images based on the first shape image set S1030. Specifically, in order to determine the shape image corresponding to the characteristic of at least one unit area of the source image, the electronic device may obtain the first characteristic information corresponding to the plurality of shape images from the first shape image set. In this case, the first characteristic information may indicate the distribution of characteristic values for each of the plurality of shape images.

Furthermore, based on the first characteristic value and the first characteristic information, the electronic device may obtain a first shape image corresponding to at least one unit area by determining which shape image matches the first characteristic value S1040. Specifically, among the characteristic values of the plurality of shape images included in the first characteristic information, the electronic device may extract the characteristic value corresponding to the first characteristic value and select the shape image having that extracted value to obtain the first shape image.

In addition, the electronic device may obtain a processed image by converting at least one unit area into the first shape image S1050.

To transform the source image into a shape preferred by the user, the electronic device may directly receive a shape image set from the user. By comparing the characteristics of the received shape image set with those of the source image, the device may provide a processed image in which part of the source image is converted into some of the shapes input by the user.

FIG. 11 is a flowchart illustrating yet another embodiment of a method in which an electronic device acquires a shape image corresponding to a unit area and obtains a processed image, according to various embodiments.

Referring to FIG. 11, the electronic device may acquire a first characteristic value based on at least one unit area included in the source image S1110. The detailed explanation of step S1110 is omitted here as it is the same as the technical content of step S710 described above.

Additionally, the electronic device may acquire a first generation parameter associated with an image generation model based on the first characteristic value S1120. The first generation parameter may represent the data required to generate a shape image, and its type may be determined by the image generation model described below. For instance, the first generation parameter may include at least one of the shape's color (e.g., RGB/Hue), intensity (e.g., Grayscale), saturation, brightness, or luminance, but is not limited thereto.

Furthermore, the first generation parameter may be defined based on the type of shape. Specifically, the first generation parameter may differ depending on the type of shape. For example, a generation parameter for creating a star-shaped image could include the number of vertices, the length (or depth) of each edge, or whether it is colored, among other factors.

Moreover, using the image generation model, the electronic device may generate a first shape image corresponding to at least one unit area based on the first generation parameter S1130. In this case, the image generation model may be an electronic configuration that receives specific inputs and outputs image data having predetermined characteristics. For instance, the image generation model may include a generative model constructed as a generative model or a CG-based image generation tool, among others, but is not limited thereto.

Here, a generative model may encompass both supervised generative models and unsupervised generative models. Specifically, the electronic device may generate shape images using an image generation model constructed based on at least one of a supervised generative model such as linear discriminant analysis (LDA) or quadratic discriminant analysis (QDA), a statistical generative model such as kernel density estimation, Pixel RNN for directly obtaining probability distributions, a VAE (Variational Auto-Encoder) for estimating probability distributions, or an unsupervised generative model using deep learning such as a GAN (Generative Adversarial Network), which generates images irrespective of data distribution. The above examples are not limiting.

Operation S1130, which involves generating a shape image using the image generation model, may include the following additional detailed operations:

The electronic device may acquire a shape-related feature based on the first generation parameter S1131. Here, a shape-related feature may refer to a feature associated with at least one attribute that composes a shape. For example, a shape-related feature may include not only shape-independent characteristics such as color (e.g., RGB/Hue), intensity (e.g., Grayscale), saturation, brightness, or luminance, but also shape-dependent characteristics such as the number of vertices, curvature, size, or overall configuration of the shape.

In addition, the electronic device may generate a first shape image that reflects the shape-related feature S1133.

Specifically, the electronic device may utilize at least a portion of the image generation model (e.g., filtering layers, feature extraction layers, etc.) to extract shape-related features such as the location and/or number of vertices, general appearance, or curvature of the shape based on the first generation parameter.

Optionally, alternatively, or sequentially, the electronic device may acquire a second generation parameter based on user input S1140. This second generation parameter may include not only shape-dependent features but also shape-independent features such as color (e.g., RGB/Hue), intensity (e.g., Grayscale), saturation, brightness, or luminance. For example, the second generation parameter input by the user may include the type of shape, shape characteristics, or a reference image similar to the shape to be generated, but it is not limited thereto. Furthermore, the second generation parameter may include abstract information (e.g., mood, feel, etc.), in which case the electronic device may process the second generation parameter in a predetermined manner (e.g., natural language processing) to extract the feature corresponding to such abstract information.

Additionally, the second generation parameter may include information regarding the type (category) of the shape to be generated. In this case, the electronic device may extract shape-related features based on the shape's category. Specifically, if the device intends to generate a first type of shape (e.g., a star shape) according to the shape category, it may extract a first shape-related feature (e.g., the number of vertices, curvature, etc.). If it intends to generate a second type of shape (e.g., a Korean-character shape), it may extract a second shape-related feature (e.g., font style, presence or absence of final consonants, etc.).

Optionally, alternatively, or sequentially, the electronic device may acquire reference data S1150. This reference data may include a reference image for the image to be generated, text indicating the type of image to be generated, or an image used for discrimination to improve the accuracy of the image to be generated (e.g., comparison data used in a GAN model), among others, but it is not limited thereto. In this case, the electronic device may extract the characteristics of the reference data based on that reference data. For instance, the device may process the text included in the reference data using natural language processing to extract the shape-related features.

In this manner, the electronic device may generate the first shape image by incorporating shape-related features. In such a case, the electronic device may train the image generation model so that the similarity between the image generated by the model and an actual image is minimized.

FIG. 12 is a diagram illustrating an example in which an electronic device generates a shape image using an image generation model, according to various embodiments.

Referring to FIG. 12, the electronic device may input the source image into an image generation model 1200 and generate a shape image based on the source image.

Specifically, the image generation model 1200 may acquire a first generation parameter (e.g., color, brightness, intensity, saturation of the shape, etc.) based on the characteristics of the unit area 1210 of the source image. In this case, the electronic device may also acquire a second generation parameter (e.g., shape type, curvature, etc.) based on user input. Additionally, the image generation model 1200 may extract at least one shape-related feature 1230 based on the first and second generation parameters. Using that shape-related feature 1230, the image generation model 1200 may generate a first shape image 1250 that reflects the shape-related feature.

FIG. 13 is a flowchart illustrating an embodiment of a method in which an electronic device acquires multiple shape images corresponding to a unit area and obtains a processed image, according to various embodiments.

Referring to FIG. 13, the electronic device may acquire a first characteristic value based on at least one unit area included in the source image S1310. A detailed explanation of step S1310 is omitted here as it is the same as the technical content of step S710 described above.

In addition, the electronic device may acquire a first shape image set that includes multiple shape images S1320. The first shape image set may be data pre-stored in the database, data received from a user, or data generated by an image generation model.

Moreover, based on the first shape image set, the electronic device may determine at least two shape images that have characteristics corresponding to the first characteristic value S1330. As the technical details regarding shape image characteristics have already been explained above, they will be omitted here. In this scenario, if the relationship between the characteristic value of the unit area and the characteristic of the shape image is defined not as a 1:1 correspondence but as a 1:n correspondence, the electronic device may determine at least two shape images corresponding to the first characteristic value. For example, the electronic device may identify at least two shape images that have characteristics matching the first characteristic value range defined based on the acquired first characteristic value.

In addition, the electronic device may obtain a first shape image based on at least two shape images S1340. In this case, the electronic device may acquire the first shape image by selecting the shape image whose characteristics are closest to the first characteristic value among the at least two shape images. However, it is not limited thereto; the electronic device may also generate a shape image based on the average of the characteristics of these two or more shape images to obtain the first shape image. Alternatively, the electronic device may arbitrarily select one among the two or more shape images to acquire the first shape image.

Moreover, the electronic device may acquire a processed image by converting at least one unit area into the first shape image S1350. A detailed explanation of step S1350 is omitted here as it is the same as the technical content of step S730 described above.

FIG. 14 is a flowchart illustrating another embodiment of a method in which an electronic device acquires multiple shape images corresponding to a unit area and obtains a processed image, according to various embodiments.

FIG. 15 is a diagram illustrating an example of a method by which an electronic device acquires multiple shape images corresponding to a unit area and obtains a processed image, according to various embodiments.

Referring to FIG. 14, the electronic device may acquire multiple characteristic values based on at least one unit area included in the source image S1410. Specifically, the electronic device may acquire two or more characteristic values (e.g., color values and brightness values, color values and intensity values, or R, G, and B values within color, etc.) for the unit area of the source image.

For instance, referring to FIG. 15, the electronic device may acquire a first characteristic value, a second characteristic value, and a third characteristic value based on the unit area 1501 of the source image 1510. In this case, the first characteristic value may represent the R value of the color in the unit area 1501, the second characteristic value may represent the G value, and the third characteristic value may represent the B value, but it is not limited thereto. In other words, the electronic device may extract the color value from the unit area 1501 of the source image 1510, and determine the multiple color values that make up the extracted color value as the characteristics of the unit area.

Referring again to FIG. 14, the electronic device may acquire multiple shape images corresponding to each of the multiple characteristic values S1420.

For example, referring to FIG. 15, the electronic device may acquire a first shape image 1521 having a characteristic corresponding to the first characteristic value, a second shape image 1523 having a characteristic corresponding to the second characteristic value, and a third shape image 1525 having a characteristic corresponding to the third characteristic value.

Referring again to FIG. 14, the electronic device may obtain a resulting shape image based on the multiple shape images S1430.

In this case, the electronic device may process the multiple shape images in a predetermined manner to obtain the resulting shape image. Specifically, the electronic device may implement different methods of obtaining the resulting shape image depending on the type of shape to be displayed; details regarding this are described in FIG. 16.

FIG. 16 is a flowchart illustrating how an electronic device may obtain a resulting shape image according to the type of shape image, according to various embodiments.

FIG. 17 is a diagram illustrating another example of how an electronic device acquires multiple shape images corresponding to a unit area and obtains a processed image, according to various embodiments.

Referring to FIG. 16, in operation S1430, the electronic device may determine the type of shape image set that contains multiple shape images S1610. Here, the type of the shape image set may refer to the category of the shape depicted in the shape image. For example, the type of the shape image set may include various types such as a star shape, a Korean-character shape, an English-character shape, or a numeric shape.

If the shape image set is of a first type, the electronic device may obtain a resulting shape image by overlapping the shapes shown in the multiple shape images S1620. In this context, the first type of shape may refer to a type of shape in which its meaning and aesthetic are maintained or enhanced even if the shape is overlapped. The electronic device may be pre-configured with and store types for each shape.

For instance, referring again to FIG. 15, if the electronic device determines that the shape image set containing the first shape image 1521, the second shape image 1523, and the third shape image 1525 is of the first type (e.g., star shapes), it may obtain the resulting shape image 1530 by overlapping the shapes depicted in the first shape image 1521, the second shape image 1523, and the third shape image 1525. Alternatively, the electronic device may obtain the resulting shape image by overlapping at least two of the shapes depicted in these images.

Additionally, if the shape image set is determined to be a second type, the electronic device may obtain a resulting shape image by selecting one among the multiple shape images S1630. In this context, the second type of shape may refer to a type of shape whose meaning and aesthetic are deemed to be compromised if it is overlapped. The electronic device may be configured in advance to store and categorize shapes by such types.

For example, referring to FIG. 17, the electronic device may acquire a first characteristic value, a second characteristic value, and a third characteristic value based on the unit area 1701 of the source image 1710, and obtain a first shape image 1721 having a characteristic corresponding to the first characteristic value, a second shape image 1723 having a characteristic corresponding to the second characteristic value, and a third shape image 1725 having a characteristic corresponding to the third characteristic value.

In this case, if the electronic device determines that the shape image set containing the first shape image 1721, the second shape image 1723, and the third shape image 1725 is of the second type (e.g., Korean characters), it may obtain the resulting shape image 1730 by selecting one among the first shape image 1721, the second shape image 1723, or the third shape image 1725. FIG. 17 shows the first shape image 1721 being chosen as the resulting shape image 1730, but it is not limited thereto; the second shape image 1723 or the third shape image 1725 may also be determined to be the resulting shape image.

Hereinafter, a user interface and user scenario provided when the shape image-based image processing method is performed by a client device will be described.

FIG. 18 is a flowchart illustrating a method of performing an image zooming operation by an electronic device in response to a zoom-in input for a source image, according to various embodiments.

FIG. 19 is a diagram illustrating an example in which an electronic device performs an image zooming operation in response to a zoom-in input for a source image, according to various embodiments.

Referring to FIG. 18, the electronic device may display the source image using a display S1810. Specifically, the electronic device may show the source image at a first position on the display. Additionally, the electronic device may receive a request to zoom in on a particular area of the source image S1820.

For example, referring to FIG. 19, the electronic device may display the source image 1920 using the display 1910. The electronic device may then receive an input 1930 requesting to zoom in on a specific area 1915 of the display. This zoom-in input 1930 may be implemented in various ways. Specifically, the electronic device may be configured to zoom in on the specific area 1915 in response to a predefined touch input (e.g., two consecutive taps), a motion in which multiple pointing inputs move away from each other on the specific area (e.g., a pinch-out gesture on the display), or a click input configured for zooming in on the specific area. However, the scope is not limited thereto.

Referring back to FIG. 18, in response to receiving the zoom-in request, the electronic device may display, using the display, a first zoomed-in image for the specific area—where the first zoomed-in image includes at least one shape image corresponding to at least one unit area within the specific area S1830.

For example, referring to FIG. 19, upon receiving the zoom-in input 1930 on the specific area 1915, the electronic device may display a first zoomed-in image 1940 for that specific area using the display. In this case, the first zoomed-in image 1940 may include at least one shape image 1945 corresponding to at least one unit area included in the specific area 1915. Specifically, the device may determine a plurality of shape images corresponding to each of the multiple pixels constituting the specific area 1915 of the source image, and obtain the first zoomed-in image 1940 by converting those multiple pixels into the multiple shape images.

When the source image is zoomed in by user input, the electronic device may decide whether to convert it into a shape image depending on whether the zoomed-in image meets certain predefined conditions. For example, if the source image is gradually zoomed in due to the user's continued zoom-in input and the resulting zoomed-in image satisfies the predefined conditions, the electronic device may convert it into a shape image. For instance, if the number of pixels included in the zoomed-in image is below a predefined threshold, the electronic device may convert at least one pixel in the zoomed-in image into at least one shape image. Also, if a conversion input for shape images is received from the user during the zooming process, the electronic device may convert at least one pixel in the zoomed-in image into at least one shape image based on the user input. In this case, the multiple shape images used for conversion may be pre-stored in the device's database or may be selected according to user input. Additionally, if an input is received from the user to change the shape image, the electronic device may be configured to change the type of shape image being converted.

Furthermore, if the electronic device receives a zoom-out input from the user for the zoomed-in image, it may redisplay the source image. In this situation, the electronic device may restore a specific area of the source image that was converted into multiple shape images back to the original pixels, but it may also be configured to display it in a restored state that still includes the converted shape images. Additionally, in this scenario, the electronic device may provide location information (e.g., body parts, etc.) of the zoomed-in image on the source image using the display.

Although FIG. 19 illustrates a scenario where the display screen is switched to show the zoomed-in image based on the user's zoom-in input, it is not limited thereto. If a zoom-in input is received for a specific area of the source image, the electronic device may display the zoomed-in image so that it at least partially overlaps with that specific area.

Furthermore, the electronic device may provide a visual effect associated with the process in which a specific area of the source image is converted into multiple shape images while the source image is being zoomed in. Specifically, the electronic device may provide a visual effect that shows the process of converting each unit area (e.g., pixel) of a specific area of the source image into multiple shape images, and display those multiple shape images after providing the visual effect.

In an embodiment, the electronic device may process the image in the aforementioned manner so that at least part of the image is converted into shape images, and then utilize the resulting processed image in various fields.

For example, based on the processed image containing multiple shape images, the electronic device may create video content, use it as synthetic data, or issue it as an NFT, among other possibilities.

### [Pixel-Based Image Processing Methods]

According to one embodiment, an electronic device may provide a pixel-based image processing function as part of its image processing procedure. In this disclosure, “pixel-based image processing” can be defined as an image processing technique that obtains a rearranged image with new visual effects by adjusting the positional characteristics of pixels included in the image.

FIG. 20 is a diagram illustrating an example of how an electronic device processes an image according to pixel-based image processing, in accordance with various embodiments.

Referring to FIG. 20, the electronic device may process a source image 2001 based on a pixel-based image processing method to obtain a processed image 2002.

In this case, the electronic device may acquire the processed image 2002 by adjusting multiple pixels included in the source image 2001, based on at least one of various predetermined operations.

Specifically, the electronic device may obtain the processed image 2002 by adjusting the positional distribution of multiple pixels included in the source image 2001 according to predetermined criteria.

For example, the electronic device may adjust the positions of multiple pixels in the source image 2001 in at least one direction, such as a longitudinal direction (e.g., the y-axis direction in the pixel distribution), a transverse direction (e.g., the x-axis direction), a diagonal direction, or a spiral direction. However, this is not limiting; in addition to the enumerated directions, the device may rearrange the pixel positions according to various other criteria, such as rearranging based on Hilbert curves/Piano curves or performing repeated iterations to achieve certain effects.

FIG. 21 is a flowchart illustrating a method by which an electronic device provides a pixel-based image processing function, according to various embodiments.

Referring to FIG. 21, the electronic device may acquire a source image that includes a first pixel group S2110. Here, the first pixel group refers to the pixels whose positions are reset according to pixel-based image processing among the pixels included in the source image, however, depending on the embodiment, it may be understood to include all pixels constituting the source image.

Additionally, the electronic device may obtain a processed image that includes second pixel group by resetting at least one characteristic of multiple pixels included in the first pixel group according to predefined conditions S2120. Here, at least one characteristic of a pixel may be represented by at least one characteristic value assigned to that pixel. For instance, the at least one characteristic of the pixel may include at least one pixel value, and specific examples include the pixel's position value (e.g., (x,y) coordinates), color value (e.g., RGB value), intensity value, brightness, saturation, etc. This is not exhaustive, however.

A detailed method of resetting pixel characteristics based on at least one among various predefined conditions will be described below.

FIG. 22 is a flowchart illustrating one embodiment of a method in which an electronic device provides a pixel-based image processing function, according to various embodiments.

Referring to FIG. 22, the electronic device may acquire a source image that includes a first pixel group S2210.

In addition, the electronic device may obtain a second pixel group by resetting the characteristics associated with the position of each pixel included in the first pixel group according to predefined conditions S2220. Here, the characteristics related to the pixel's position may include the pixel's position value. Specifically, the electronic device may acquire the second pixel group by changing the location coordinates of at least some of the pixels in the first pixel group on the image. For example, the electronic device may obtain the second pixel group by rearranging (or relocating) the positions of multiple pixels included in the first pixel group.

Operation S2220 of the electronic device may include the following detailed operations:

Specifically, the electronic device may set a particular position in the source image as a reference position S2221. This reference position may be configured based on user input. It may correspond to a point, a line, or a plane on the source image. The reference position may also be preset. For example, the electronic device may set the top area of the source image, the bottom area of the image, the center area of the image, or at least one edge area of the image as the reference position, but is not limited thereto.

In addition, the electronic device may relocate the positions of the pixels in the first pixel group according to predefined conditions, based on the reference position S2223. These predefined conditions may be set based on at least one characteristic of the pixels in the first pixel group. Specifically, the electronic device may adjust the positions of the pixels based on the pixel values (e.g., color, intensity, brightness, saturation) of the pixels in the first pixel group. In other words, the electronic device may adjust a second characteristic value of the pixels based on a first characteristic value of the pixels included in the first pixel group. For example, the electronic device may adjust the positions of the pixels so that those with a larger intensity value are placed closer to the reference position, but this is not limiting.

Furthermore, the electronic device may acquire a processed image that includes the second pixel group S2230. In this case, the distribution of the color-related characteristics of the pixels included in the processed image may be identical to the distribution of color-related characteristics of the pixels included in the source image. Specifically, the distribution of color values of the pixels in the processed image may be the same as the distribution of color values of the pixels in the source image. In other words, the electronic device may acquire the processed image in such a way that the color distribution of the pixels in the source image is preserved.

Because only the position of the pixels was rearranged, the color distribution of the image remains the same, yet the resulting image can provide a distinct visual effect.

FIG. 23 is a flowchart illustrating another embodiment of a method in which an electronic device provides a pixel-based image processing function, according to various embodiments.

Referring to FIG. 23, the electronic device may acquire a source image that includes a first pixel group S2310.

Additionally, the electronic device may obtain a second pixel group by resetting the visual characteristics of each pixel included in the first pixel group according to predefined conditions S2320. Here, the visual characteristics of a pixel may include the pixel's color, brightness, saturation, or intensity, among others.

Operation S2320 of the electronic device may include the following additional detailed operations:

Specifically, the electronic device may designate at least one pair of pixels among the pixels included in the first pixel group S2321. In doing so, the electronic device may arbitrarily select at least two pixels among those included in the first pixel group to form the at least one pair. Alternatively, the electronic device may designate at least one pair of pixels by selecting at least two pixels among the first pixel group based on some predetermined rule. For example, the electronic device may consider differences in characteristic values reflecting visual characteristics (e.g., color value, intensity value, brightness value, or saturation value) and positional differences among the pixels in the first pixel group to designate at least one pixel pair. As an example, the device might choose two pixels with a large positional difference and a significant difference in color values as a pair, although this is not limiting. In another example, the electronic device may check the color and position values of the pixels in the first pixel group and designate a pixel pair so that pixels with similar color values also have similar position values, but again this is not limiting.

Additionally, the electronic device may obtain the second pixel group by mutually exchanging at least one among the color, brightness, saturation, or intensity values of the at least one pair of pixels S2323.

In addition, the electronic device may acquire a processed image that includes the second pixel group S2330. In this scenario, the distribution of color-related characteristics of the pixels included in the processed image may be identical to the distribution of color-related characteristics of the pixels included in the source image. Specifically, the distribution of color values of the pixels in the processed image may be the same as that of the pixels in the source image. In other words, the electronic device may acquire the processed image so as to maintain the color distribution of the pixels in the source image.

Because the color of certain pixels was exchanged with that of other pixels, the overall color distribution remains the same, yet the resulting image may provide a different visual effect.

FIG. 24 is a flowchart illustrating one embodiment of a method in which an electronic device resets the characteristics of the pixels in an image based on user input, according to various embodiments.

FIG. 25 is a diagram illustrating one example of how an electronic device resets the characteristics of the pixels in an image based on user input, according to various embodiments.

Referring to FIG. 24, the electronic device may display the source image using a display S2410. The electronic device may also receive user input S2420. In this case, the user input may include a request to transform the source image, and it may be received via an input to the display. For instance, the electronic device may receive user input based on a touch input or motion input made on the display.

For example, referring to FIG. 25, the electronic device may display the source image 2510 using the display 2500. The electronic device may also receive a first user input 2501 through the display 2500. The first user input 2501 could be an input associated with a specific position 2515 in the source image 2510 shown on the display 2500. For instance, the first user input 2501 may be a continuous touch input made between at least two points corresponding to the two ends of that specific position 2515, a touch input on at least two points corresponding to the two ends of the position 2515, or a motion input corresponding to those at least two points. However, these are not the only possibilities; any general user input operation that can specify the particular position 2515 may be included.

Referring back to FIG. 24, the electronic device may set a specific position on the source image as a reference position based on the user input S2430. Specifically, the electronic device may receive a user input associated with a particular position on the source image displayed on the screen, and set that position as the reference position based on receiving the user input.

Further, the electronic device may relocate multiple pixels included in the source image based on the reference position S2540. In this case, the electronic device may provide visual effects illustrating the process of repositioning the pixels. For example, the device may provide a simulation via the display showing the movement of pixels based on the reference position. Specifically, the electronic device may visually present a simulation of the pixels included in the source image moving, by playing it through the display. This simulation may be a series of frames that visualize in real time the changes occurring as the image processing algorithm is executed, but it is not limited thereto. It could also be video content selected from among multiple pre-stored videos based on the image processing algorithm being performed.

Moreover, the electronic device may display the processed image using the display S2450.

For example, referring to FIG. 25, the electronic device may set a specific position 2501 designated by the first user input 2515 as the reference position 2520. In this context, the reference position 2520 may serve as the basis for rearranging the positions of the pixels included in the source image 2510.

Here, the electronic device may relocate the pixels included in the source image 2510 based on the reference position 2520, while determining the direction and/or position of the relocation according to the visual characteristics of the pixels. Specifically, the electronic device may rearrange pixels so that those having a greater pixel value (e.g., color, intensity, saturation, brightness, etc.) are placed closer to the reference position, but it is not limited to this approach.

Additionally, the electronic device may present, through the display 2500, a first simulation 2530 illustrating the scene of the pixels in the source image 2510 moving. The first simulation 2530 may be video content depicting the movement of pixels in the image, but is not limited thereto.

Furthermore, the electronic device may display the processed image 2540, in which the pixels have been repositioned, through the display 2500.

FIG. 26 is a flowchart illustrating another embodiment of a method in which an electronic device resets the characteristics of the pixels in an image based on user input, according to various embodiments.

FIG. 27 is a diagram illustrating another example of how an electronic device resets the characteristics of the pixels in an image based on user input, according to various embodiments.

Referring to FIG. 26, the electronic device may display the source image including a first pixel group, using a display S2610.

In addition, if a motion of the user device is detected, the electronic device may output a first simulation depicting a visual effect in which the first pixel group moves in a direction corresponding to the motion of the device S2620. In this scenario, the electronic device may include at least one processor within the user device (e.g., a mobile phone). Specifically, the electronic device may detect the motion of the device by using at least one sensor (e.g., an inertial sensor or another motion-detection sensor) included in the user device. In that case, the electronic device may determine the direction corresponding to the motion of user device using at least one sensor.

Accordingly, the electronic device may reset the positions of the pixels included in the first pixel group based on the direction corresponding to the motion of user device. Specifically, the electronic device may relocate the pixels so that the pixels in the first pixel group are arranged in accordance with the pixel values (e.g., color value, intensity, brightness, or saturation) reflecting the pixel's visual characteristics along the direction of the motion of device. For instance, the electronic device may move the pixels so that those in the first pixel group are arranged in ascending (or descending) order of color values along the direction of the motion of user device, but this is not exhaustive.

In this scenario, the electronic device may transmit, through the display, a first simulation depicting the process in which the pixels in the first pixel group move according to the predetermined criteria. The first simulation may be video content describing how the pixels shift in the image, but it is not limited thereto.

Additionally, in this scenario, the electronic device may display a processed image indicating the result of the movement of the pixels included in the first pixel group, using the display. Specifically, the electronic device may acquire a processed image by obtaining a second pixel group based on the first pixel group. In this case, the processed image may contain the second pixel group that has the same distribution of visual characteristics (e.g., color distribution) as the first pixel group, but differs in its distribution of positional characteristics (e.g., position distribution).

Further, if no motion of the user device is detected while transmitting the first simulation, the electronic device may transmit a second simulation indicating a visual effect in which the first pixel group is restored to its initial position S2630. In this context, the electronic device can detect that the motion of the user device has ceased by using at least one sensor (e.g., an inertial sensor or other motion-detection sensor) included in the user device. In that case, the electronic device may restore the pixels whose positions have been moved (or are in the process of being moved) back to their initial positions in the source image. The specific algorithm by which the electronic device restores pixel positions may be configured based on the algorithm that moved the pixels according to the terminal's motion. In other words, the device's pixel position restoration algorithm may be set to revert positions that were reset by the movement algorithm back to their previous state.

Additionally, in this scenario, the electronic device may transmit a second simulation via the display, depicting the scene in which the pixels are restored to their initial positions as a visual effect.

For instance, referring to FIG. 27, the electronic device may display the source image 2710 via the display 2700. If the user terminal's motion 2701 is detected (e.g., by a processor), the electronic device may output a first simulation 2720 via the display 2700 that corresponds to the direction of the user motion. At this time, the first simulation 2720 may be video content visually representing the process of moving multiple pixels included in the source image 2710, although it is not limited to this.

Once the relocation of the pixels in the source image 2710 according to the terminal's motion direction is complete, the electronic device may display a processed image 2740 through the display 2700 in which the pixel positions have been rearranged. In this situation, the electronic device may choose not to perform additional pixel rearrangement if the terminal continues motion in the same direction. In other words, if the rearrangement of pixels in the source image according to the terminal's motion is complete, the electronic device may stop transmitting the first simulation 2720 regardless of whether the terminal continues to move. However, if the direction of the terminal's motion changes, the device may once again rearrange the pixels included in the source image 2710 based on the updated direction. In this case, the electronic device may transmit a simulation depicting the movement of the pixels according to the changed direction as a visual effect.

If, while the electronic device is transmitting the first simulation 2720 or displaying the processed image 2740, the user terminal's motion ceases to be detected (i.e., the motion stops), the device can adjust the positional characteristics of the pixels so that the first pixel group returns to its initial position, and at the same time transmit a second simulation 2730 via the display 2700 depicting the visual effect of the pixels returning to the initial position. Likewise, if the device receives a user input requesting the pixel restoration while transmitting the first simulation 2720 or displaying the processed image 2740, it may adjust the pixel positions so that the first pixel group is restored to its initial position and simultaneously transmit the second simulation 2730 showing the pixels returning to their initial position as a visual effect. Once the pixel restoration is complete, the electronic device can display the source image 2710 again via display 2700.

FIG. 28 is a flowchart illustrating a method of image transformation using a pixel map, according to various embodiments.

FIG. 29 is a diagram illustrating an example of an image transformation method using a pixel map, according to various embodiments.

Referring to FIG. 28, the electronic device may acquire a first pixel map of which the positions of multiple pixels included in the source image have been reset S2810. In this case, a pixel map can be defined as an image or map in which pixel characteristics included in the source image are reset, according to FIGS. 21-23 described above. For example, the first pixel map may represent the distribution of color values according to position in the image; however, it is not restricted to that and can also represent distributions of positional and/or visual characteristics of pixels, such as the distribution of brightness based on hue, and so forth.

The electronic device may acquire the first pixel map by arranging the pixels so that the distribution of pixel values (e.g., color value, intensity value, brightness, or saturation) associated with their visual characteristics becomes apparent, based on multiple pixels included in the source image.

In addition, based on user input, the electronic device may identify a second pixel map in which at least part of the first pixel map is modified S2820. The electronic device may then acquire a processed source image based on the second pixel map S2830. Here, the processed source image may refer to an image in which at least some of the pixels from the source image have altered characteristics. In this scenario, the electronic device may acquire a processed source image whose positional characteristics differ from those of the source image while preserving the same visual characteristics, or an image whose positional and visual characteristics both differ from those of the source image.

For instance, referring to FIG. 29, the electronic device may obtain a first pixel map 2920 by rearranging the pixels included in the source image 2910 according to certain conditions. In that case, the electronic device may identify a second pixel map 2930, in which the characteristics of at least some of the pixels included in the first pixel map 2920 have been changed, based on user input concerning the first pixel map 2920. The second pixel map 2930 may be one in which the visual characteristics of at least some of the pixels included in the first pixel map 2920 have been modified, but is not limited thereto.

Additionally, the electronic device may acquire a processed source image 2940 based on the second pixel map 2930. Specifically, the device may obtain the processed source image 2940 by restoring the positional distribution of the multiple pixels included in the second pixel map 2930. Corresponding to the positional changes of the pixels that occurred when the source image 2910 was converted into the first pixel map 2920 (e.g., reversing that positional change), the electronic device can transform the second pixel map 2930 into the processed source image 2940. However, because some of the characteristics of the pixels in the first pixel map may have been changed based on user input, the characteristics of the pixels in the processed source image may differ from those in the source image.

Specific examples of acquiring a processed source image based on user input are described with reference to FIGS. 30 and 31.

The electronic device can provide a pixel map corresponding to the source image via the display, and change the image's properties based on user input directed to that pixel map. For example, the device may provide, through a user terminal, a pixel map showing the color distribution of the image, and if the color distribution depicted by the pixel map is adjusted by the user, the device can generate a processed image reflecting the adjusted color distribution and provide it to the user terminal.

FIG. 30 is a flowchart illustrating an embodiment in which an electronic device transforms an image by reflecting changes in a pixel map identified based on user input, according to various embodiments.

Referring to FIG. 30, the electronic device may acquire a first pixel map in which the positions of multiple pixels included in the source image have been reset S3010. The electronic device may then display the source image and the first pixel map using the display S3020.

Additionally, based on user input that enlarges a first color region included in the first pixel map, the electronic device may provide a processed source image that reflects the color ratio occupied by the enlarged first color region in the first pixel map S3030.

Specifically, the electronic device may adjust the ratio that the first color region occupies in the first pixel map according to the user input that enlarges the first color region. Moreover, based on the user input, the device may identify a second pixel map that includes the enlarged first color region. In this scenario, the second pixel map may be one in which the proportion of the first color region within the first pixel map is modified. In addition, the electronic device may acquire a processed source image based on the second pixel map. The color distribution of that processed source image may differ from the source image, as enlarging the proportion of a specific color region in the pixel map in response to user input causes the device to obtain a processed source image reflecting the changed color ratio.

FIG. 31 is a flowchart illustrating another embodiment in which an electronic device transforms an image by reflecting changes in a pixel map identified based on user input, according to various embodiments.

Referring to FIG. 31, the electronic device may acquire a first pixel map in which the positions of multiple pixels included in the source image have been reset S3110. The electronic device may also display the source image and the first pixel map using the display S3120.

Moreover, based on user input that shifts a first area and a second area included in the first pixel map, the electronic device may identify a second pixel map in which the first and second areas are shifted S3130.

Then, the electronic device may provide a processed source image based on the second pixel map S3140.

In this manner, the electronic device can adjust the color arrangement in the source image by shifting areas within the pixel map according to user input. Specifically, the device can shift the color of a certain area in the source image with the color of another area in response to user input. To do so, the electronic device may acquire and present to the user a first pixel map representing the color distribution of the source image, and then obtain a processed source image based on user input directed to the first pixel map.

The electronic device may obtain various information related to the image based on a pixel map that reflects the image's attributes (e.g., color distribution, intensity distribution, brightness distribution, saturation distribution, etc.). Because the pixel map represents the image's properties according to predefined criteria, processing the pixel map in a certain way can allow the device to obtain information related to the image's properties.

FIG. 32 is a diagram illustrating information that can be acquired based on a pixel map by an electronic device, according to various embodiments.

Referring to FIG. 32, the electronic device may acquire a pixel map in which the positions of multiple pixels included in the source image have been reset S3210.

In addition, the electronic device may acquire at least one among color distribution information, color ratio information, or dominant color information, based on the pixel map S3220.

Here, the color distribution information may be associated with the distribution of color values corresponding to multiple pixel values included in the source image. For example, color distribution information may include data that visually represents the distribution of various colors in the image, or data that arranges the color values of the pixels included in the image according to predefined sorting criteria (e.g., ascending or descending order), but is not limited thereto.

Additionally, the color ratio information may be associated with the ratio of color values corresponding to multiple pixel values contained in the source image. For example, color ratio information may include data indicating the proportions of the various colors in the image, but is not limited thereto.

Further, the dominant color information may be associated with the color that has the highest proportion in the image. For instance, the dominant color information may include data regarding a particular color that makes up the largest percentage in the image, but is not limited thereto.

Operation S3220 of the electronic device may include the following additional detailed operations:

The electronic device may segment the pixel map into multiple color areas, based on boundary points where the difference in pixel values among the pixels included in the pixel map is greater than or equal to a threshold S3221. To obtain various information related to attributes (e.g., color) from the pixel map, the electronic device can segment the pixel map according to predefined criteria and extract various pieces of information associated with the image's attributes from the resulting segmented areas. In other words, through the segmentation operation, the device may identify the color ratios of the pixels included in the source image (or the pixel map).

In addition, based on the ratio that the segmented multiple color areas occupy in the pixel map, the electronic device may acquire at least one among the color distribution information, color ratio information, or dominant color information of the source image S3223.

The electronic device may obtain not only various types of information related to the image's attributes (e.g., color distribution information, color ratio information, dominant color information, etc.) but also secondary information related to the image by utilizing this information.

For example, the electronic device may acquire color similarity information based on at least one among the color distribution information, color ratio information, or dominant color information S3230. In one example, the electronic device may acquire similarity information by comparing one or more of the color distribution information, color ratio information, or dominant color information of the source image to that of another image. Alternatively, the electronic device may compute parameters for judging similarity based on at least one of color distribution information, color ratio information, or dominant color information, and acquire it as similarity information. In this way, the electronic device can use the obtained similarity information as a key for image search.

Alternatively, for instance, the electronic device may acquire color recommendation information based on at least one among color distribution information, color ratio information, or dominant color information S3240. In this scenario, the electronic device may obtain the color recommendation information so that at least one among the color distribution information, color ratio information, or dominant color information matches a predefined criterion, based on the color ratio of the source image. This predefined criterion might represent a color ratio for achieving harmonious color proportions. The electronic device may then acquire the color recommendation information and provide it through the user terminal.

According to one embodiment, an electronic device may obtain images of a particular object over time and process the acquired images to obtain information about that object that can be identified as time progresses.

FIG. 33 is a flowchart illustrating another example of how an electronic device acquires information based on a pixel map, according to various embodiments.

Referring to FIG. 33, the electronic device may acquire a first image that visually represents a first object at a first point in time, and a second image that visually represents the same first object at a second point in time S3310.

Additionally, the electronic device may obtain a first pixel map in which the positions of multiple pixels included in the first image are reset, and a second pixel map in which the positions of multiple pixels included in the second image are reset S3320.

Furthermore, by comparing the color information of the first image identified based on the first pixel map with the color information of the second image identified based on the second pixel map, the electronic device may provide information about how the status of the first object changes between the first point in time and the second point in time S3330. Specifically, the electronic device can determine changes in the color ratio between the first point in time and the second point in time based on the color information of the first image and the second image, and then acquire status change information of the first object using these changes in color ratio. For example, depending on the color ratio changes, the device may identify changes in the object's health condition, emotional state, or the like. In a specific example, if the proportion of red color in the images of the first object increases over time, the electronic device could determine that the first object is in an excited or elevated state, although the scope is not limited thereto.

According to one embodiment, the electronic device may provide a pixel transition function among multiple images. Specifically, following a predetermined algorithm, the electronic device may map the pixels of a first image onto a second image to acquire a processed image in which the pixels of the first image have transitioned to the second image. In such a scenario, the processed image can reflect the color of the first image and the shape of the second image. More precisely, as the pixels of the first image transition onto the second image, the device can maintain the color distribution of the first image but preserve the color distribution of the second image in a way that retains its shape, thus obtaining a processed image that reflects the shape of the second image. Here, “transition” may be interpreted as a pixel's movement, but it is not limited thereto. In this disclosure, a transition operation may include an operation that changes the pixel values of the pixels in the second image to the pixel values of the pixels in the first image according to predetermined criteria, or adjusts the pixel values of the second image based on those of the first image.

Using this approach, the electronic device can utilize the pixels of the source image (the first image) as is to create the ambiance of a target image (the second image), while potentially generating an entirely different atmosphere by altering the colors relative to the original target image.

Hereinafter, a detailed explanation will be provided for the specific functions of this pixel transition feature and how the user interface may be configured.

### [How Pixels are Transferred Between Images]

FIG. 34 is a flowchart illustrating a method for an electronic device to provide a pixel transition function, according to various embodiments.

Referring to FIG. 34, the electronic device may acquire a source image and a target image S3410. Here, the source image may refer to an image that contains pixels to be transitioned, and the target image may refer to an image to which pixels included in the source image are to be transitioned. Additionally, the electronic device may perform bidirectional pixel transitions between the source image and the target image.

At this time, the electronic device may establish criteria for transitioning the pixels included in the source image to the target image. By defining a correspondence between the attributes of the source image and the attributes of the target image, the electronic device may set these transition criteria.

Specifically, the electronic device may acquire a correspondence between the characteristics of multiple pixels included in the source image and the characteristics of multiple pixels included in the target image S3420. These pixel characteristics may include the distribution of color, brightness, saturation, intensity, and so forth, but are not limited thereto. The detailed method by which the electronic device defines a correspondence between pixel characteristics is described with reference to FIGS. 35 and 36.

In addition, based on the correspondence, the electronic device may acquire a processed image in which the color-related characteristics of the source image are reflected in the target image S3430. Specifically, by adjusting the pixel values of the pixels included in the target image according to the acquired correspondence between pixel characteristics, the electronic device may obtain the processed image.

FIG. 35 is a flowchart illustrating a method for providing a pixel transition function based on the correspondence between images, according to various embodiments.

FIG. 36 is a diagram illustrating a concrete example in which an electronic device provides a pixel transition function between images based on their correspondence, according to various embodiments.

Referring to FIG. 35, the electronic device may acquire a first image and a second image S3510.

In addition, the electronic device may identify a first pixel map by representing the multiple pixels included in the first image on a coordinate space defined by one or more pixel attributes S3520. Likewise, the electronic device may identify a second pixel map by representing the multiple pixels included in the second image on a coordinate space defined by one or more pixel attributes S3530. At this time, the first and second pixel maps may be represented on a 2D coordinate space defined by a first pixel attribute and second pixel attribute. For instance, the first and second pixel maps may be plotted in a 2D space where the axes are hue (color) and brightness. Alternatively, the first and second pixel maps may be represented in an n-dimensional coordinate space defined by three or more attributes.

For example, referring to FIG. 36, the electronic device may acquire a first image 3610 and a second image 3620. The device may identify a first pixel map 3630 based on the first image 3610, and a second pixel map 3640 based on the second image 3620. In this scenario, the first pixel map 3630 and the second pixel map 3640 may be represented in a 2D coordinate space defined by a first pixel attribute (e.g., hue) and a second pixel attribute (e.g., brightness).

Based on the positional correspondence between the first pixel map corresponding to the first image and the second pixel map corresponding to the second image, the electronic device may acquire a processed image that reflects the characteristics of the first and second images. Specifically, the electronic device may acquire a processed image that retains the positional characteristics of the first image and the color characteristics of the second image. For example, the electronic device may obtain a processed image by adjusting the color values of multiple pixels in the first image to match the corresponding color values of multiple pixels in the second image.

Specifically, referring again to FIG. 35, the electronic device may identify a second point on the second pixel map corresponding to the location of a first point on the first pixel map, where the first point corresponds to a first pixel included in the first image S3540. The position of the first point may indicate its coordinates in the coordinate space where the first pixel map is plotted. In other words, the electronic device checks the first point's coordinates on the first pixel map and then locates the second point on the second pixel map that occupies those same coordinates.

Additionally, the electronic device may identify a second pixel on the second image that corresponds to the second point S3550. In this way, the electronic device can define a correspondence between the pixels of the first image and the pixels of the second image, including the correspondence between the first pixel and the second pixel.

Furthermore, the electronic device may obtain a third pixel based on the first pixel and its corresponding second pixel S3560. The device may then acquire a processed image that includes this third pixel S3570. In this scenario, the electronic device may determine the third pixel based on the correspondence between the first and second pixels. Specifically, the device may obtain the third pixel by adjusting the second pixel's color value to match that of the first pixel to which it corresponds. Alternatively, the device may convert the second pixel into the corresponding first pixel. In this way, the electronic device can define a correspondence between pixels included in different images and thereby acquire a processed image by transitioning (or swapping) the attributes of corresponding pixels.

For instance, referring to FIG. 36, the electronic device may identify a first point 3631 on the first pixel map 3630 corresponding to a first pixel 3611 included in the first image 3610. The device can locate a second point 3641 on the second pixel map 3640 that corresponds to the position occupied by the first point 3631 on the first pixel map 3630. Then, the device may identify a second pixel 3621 in the second image 3620 that corresponds to the second point 3641. Next, the device can obtain a third pixel 3651 based on the first pixel 3611 and the second pixel 3621, and thus acquire a processed image 3650 containing the third pixel 3651. In this case, the color value of the third pixel 3651 may be the same as that of the first pixel 3611, and its position value may be the same as that of the second pixel 3621. Here, the processed image 3650 may be an image reflecting the color of the first image 3610 and the shape of the second image 3620. By transferring the color distribution of the first image 3610 to the second image 3620, the electronic device may obtain a processed image 3650 in which the color of the first image 3610 is reflected in the second image 3620.

FIG. 37 is a flowchart illustrating one embodiment of a method by which an electronic device provides a pixel transition function between images of different scales, according to various embodiments.

FIG. 38 is a diagram illustrating an example of one embodiment of how an electronic device provides a pixel transition function between images of different scales, according to various embodiments.

Here, an image's “scale” refers to its size. When images are composed of pixels of the same size, the scale of an image may correspond to the total number of pixels, or more specifically, how many pixels are arranged along its horizontal and vertical axes.

Referring to FIG. 37, the electronic device may acquire a first sampling image of a first scale based on the first image S3710. The device may also acquire a second sampling image of the first scale based on the second image S3720. In other words, by sampling the first and second images, which have different scales, the electronic device may obtain a first sampling image and a second sampling image that have the same scale.

For instance, referring to FIG. 38, the electronic device may acquire a first image 3810 and a second image 3820, where the second image 3820 has a different scale than the first image 3810. In this situation, the electronic device may obtain a first sampling image 3815, which has a first scale, based on the first image 3810. To do so, the device may sample at least part of the first image. Specifically, the device may form a sampling region 3814 based on an intermediate region 3813 of the first image 3810, and obtain a first sampling image 3815 that includes both the first image 3810 and the sampling region 3814. In this case, the distribution of pixel characteristics within the sampling region 3814 may correspond to the distribution of pixel characteristics within the intermediate region 3813. Similarly, the electronic device may obtain a second sampling image 3825, based on the second image 3820, in the same manner.

Referring again to FIG. 37, the electronic device may acquire a processed image based on the correspondence between the characteristics of the first sampling image and the characteristics of the second sampling image S3730. In this case, the detailed method of obtaining the processed image using the correspondence between pixels may be applied in the same manner as described in FIG. 35.

For example, referring to FIG. 38, the electronic device may identify a first pixel map 3830 based on the first sampling image 3815, and a second pixel map 3840 based on the second sampling image 3825. The device can then locate a first point 3831 on the first pixel map 3830 corresponding to a first pixel 3811 in the first sampling image 3815. Next, it can find a second point 3841 in the second pixel map 3840 with coordinates that correspond to the first point 3831, and a second pixel 3821 in the second sampling image 3825 that corresponds to the second point 3841. Furthermore, using the correspondence between the first sampling image 3815 (which contains the first pixel 3811) and the second sampling image 3825 (which contains the second pixel 3821), the electronic device can obtain a third pixel 3851 and thereby acquire a processed image 3850 that includes the third pixel.

FIG. 39 is a flowchart illustrating another embodiment of a method in which an electronic device provides a pixel transition function between images of different scales, according to various embodiments.

FIG. 40 is a diagram illustrating an example of another embodiment of how an electronic device provides a pixel transition function between images of different scales, according to various embodiments.

Referring to FIG. 39, the electronic device may acquire a first pixel map based on the first image and a second pixel map based on the second image S3910.

Furthermore, the electronic device may obtain a first normalized pixel map by normalizing the first pixel map to a particular scale and a second normalized pixel map by normalizing the second pixel map to the first scale S3920. Specifically, the electronic device may create the first normalized pixel map by normalizing the coordinates of the first pixel map (which is defined on a coordinate space of a certain first scale) into a coordinate space defined by a particular scale (e.g., a [0,1] space). Likewise, the device may obtain the second normalized pixel map by normalizing the second pixel map (which is defined on a coordinate space of a second scale) into the same particular-scale coordinate space (e.g., [0,1]).

For example, referring to FIG. 40, the electronic device may acquire a first pixel map 4030 based on a first image 4010 and a second pixel map 4040 based on a second image 4020. The device may then obtain a first normalized pixel map 4050 by normalizing the coordinates of the first pixel map 4030 to a particular scale (e.g., [0,1]), and a second normalized pixel map 4060 by normalizing the coordinates of the second pixel map 4040 to the same particular scale (e.g., [0,1]). In this scenario, the first pixel 4011 on the first image 4010 may correspond to a first point 4031 on the first pixel map 4030, and through coordinate normalization, it may correspond to a first normalized point 4051 on the first normalized pixel map 4050. Likewise, the second pixel 4021 on the second image 4020 may correspond to a second point 4041 on the second pixel map 4040, and via normalization, a second normalized point 4061 on the second normalized pixel map 4060.

Referring once again to FIG. 39, the electronic device may obtain a processed image based on the correspondence between the first image and the second image determined from the first normalized pixel map and the second normalized pixel map S3930.

For example, referring to FIG. 40, the electronic device may identify a second normalized point 4061 on the second normalized pixel map 4060 that has the same coordinates as a first normalized point 4051 on the first normalized pixel map 4050. By identifying the second point 4041 on the second pixel map (or the second pixel 4021 on the second image) that corresponds to the second normalized point 4061, the electronic device can determine which pixel in the second image (4021) corresponds to the first pixel 4011 in the first image. Based on the correspondence between the first and second images (4010 and 4020) that includes the relationship between the first pixel 4011 and the second pixel 4021, the electronic device may obtain a processed image 4070 containing a third pixel 4071.

According to one embodiment, the electronic device may perform the above-described pixel transition function based on user input, and provide it through a user interface.

FIG. 41 is a diagram illustrating an embodiment in which an electronic device provides a pixel transition function based on user input, according to various embodiments.

Referring to FIG. 41, the electronic device may display the source image 4110 and the target image 4130 via the display 4100.

Here, the electronic device may receive user input regarding a target area 4135 of the target image 4130. Such user input may be input corresponding to the target area 4135 on the display 4100 (e.g., a touch input or a swiping gesture), but is not limited thereto.

In addition, the electronic device may identify at least one region in the source image 4110 corresponding to the target area 4135 of the target image. In doing so, the device may determine which region corresponds to the target area 4135 based on the characteristics of both the source image and the target image. More specifically, by finding at least one pixel on the pixel map corresponding to the target image that has the same characteristics and location as the target area 4135, the device can locate at least one region on the source image. For instance, the electronic device may identify a first region 4111, a second region 4112, and a third region 4113 corresponding to the target area 4135 in the target image. In such a case, the device may visually highlight or indicate the identified region(s) through the display 4100.

Furthermore, the electronic device may obtain a processed image 4150 by adjusting the characteristics of the pixels included in the target area corresponding to that at least one region, based on the characteristics of the pixels contained in the identified region(s) of the source image. For instance, the device may map at least one pixel included in at least one identified region of the source image onto the target area 4135, thereby obtaining a processed image 4150 containing a transition area 4155. In this case, the color of the pixels in the transition area 4155 can correspond to that of the pixels in at least one region (4111, 4112, 4113) of the source image. The device may provide a simulation of the color of the source image region(s) (4111, 4112, 4113) transferring to the target area 4135 of the target image, displayed on the screen 4100.

In other words, the electronic device may provide a processed image in which the color of the pixels has been transitioned by converting the area on the target image (where the user input was received) to the color of the corresponding region(s) in the source image.

According to one embodiment, the electronic device may provide a processed image by transferring the characteristics of multiple images onto a first image.

FIG. 42 is a diagram illustrating one embodiment of a method by which the electronic device processes a target image based on multiple images, according to various embodiments.

Referring to FIG. 42, the electronic device may process a target image 4210 based on multiple images (4220, 4230, 4240) to obtain a processed image 4250.

In this scenario, the electronic device may divide the target image 4210 into multiple regions and process each of those divided regions using multiple images, thus acquiring the processed image 4250. Specifically, by focusing on a first predetermined region 4211 on the target image 4210, the device may obtain a first processed region 4251 that reflects the characteristics of the first image 4220. Likewise, with respect to a second predetermined region 4212 on the target image 4210, the device may obtain a second processed region 4252 that reflects the characteristics of the second image 4230; and based on a third predetermined region 4213, it may obtain a third processed region 4253 that reflects the characteristics of the third image 4240. Consequently, the electronic device may acquire the processed image 4250 comprising the first processed region 4251, the second processed region 4252, and the third processed region 4253. In this case, for instance, the color distribution of the first processed region 4251 included in the processed image 4250 may correspond to the color distribution of the first image 4220.

The specific method by which the electronic device acquires a processed image by transferring (e.g., color) attributes of at least one image onto a particular region of a target image may be the same as those described in FIGS. 35 through 40.

For example, in a target image depicting a person, the electronic device may obtain a processed image by transferring the characteristics of the first, second, and third images (each having distinct colors) to the regions corresponding to the person's lips, hair, and face, respectively.

FIG. 43 is a diagram illustrating another embodiment of a method by which an electronic device processes a target image based on multiple images, according to various embodiments.

Referring to FIG. 43, the electronic device may process the target image 4310 based on multiple images (4320, 4330, 4340) to acquire a processed image 4360.

In this scenario, the electronic device may create a source image 4350 using multiple images, and then acquire a processed image 4360 by transferring the attributes of the source image 4350 to the target image 4310. For instance, the electronic device may obtain the source image 4350 based on the first image 4320, the second image 4330, and the third image 4340. The source image 4350 could then be an image reflecting the characteristics of these three images (4320, 4330, 4340). For example, the characteristic of a first region in the source image 4350 might correspond to the characteristic of the first image 4320, the characteristic of a second region in the source image might correspond to that of the second image 4330, and the characteristic of a third region might correspond to that of the third image 4340. To achieve this, the electronic device may normalize the scale of at least one image to the scale of at least one region of the source image.

In doing so, the ratio among the first image 4320, the second image 4330, and the third image 4340 for constructing the source image 4350 may be predetermined. Specifically, to incorporate more of the atmosphere of a particular image into the processed image, the electronic device may define the ratio among the first, second, and third images (4320, 4330, 4340) beforehand.

Additionally, by adjusting the pixel characteristics of the target image 4310 based on the pixel characteristics included in the source image 4350, the electronic device may obtain a processed image 4360.

A detailed method by which the electronic device acquires a processed image by transferring (e.g., color) attributes of the source image onto the target image can be the same as those described in FIGS. 35 to 40.

According to one embodiment, the electronic device may provide a pixel transition function using a trained deep learning model.

Below is a detailed description of how the electronic device offers a pixel transition function between images using a deep learning model, as well as how this deep learning model is trained.

FIG. 44 is a diagram illustrating a method by which an electronic device performs a color transition between shape images using a deep learning model, according to various embodiments.

Referring to FIG. 44, by processing multiple shape images (4410, 4420) using an AI model 4400 implemented with at least one deep learning model, the electronic device may acquire multiple processed shape images (4415, 4425).

Here, the device may obtain the processed shape images (4415, 4425) by exchanging colors between the multiple shape images (4410, 4420) that are input. For instance, by inputting a first shape image 4410 and a second shape image 4420 into the AI model 4400, the electronic device may identify the latent characteristics of both the first and second shape images. Such latent characteristics may encompass the color attributes and/or shape-related attributes of the shape images.

By reflecting the color characteristics of the first shape image into the second shape image 4420, the electronic device may acquire a second processed shape image 4425. Likewise, by reflecting the color characteristics of the second shape image into the first shape image 4410, it may acquire a first processed shape image 4415.

Below is a detailed description of how the electronic device exchanges color characteristics between shape images using a deep learning model.

FIG. 45 is a diagram illustrating a method by which an electronic device creates a processed shape image by exchanging color characteristics between shape images via a deep learning model, according to various embodiments.

Referring to FIG. 45, the electronic device may input a first shape image 4510 to a first input module 4501a, and a second shape image 4520 to a second input module 4501b.

Here, the first input module 4501a and second input module 4501b may include an encoder, an input layer of a neural network, a preprocessing model for deep learning input, or the like, but are not limited thereto.

Additionally, based on at least one of the first shape image 4510 and the second shape image 4520, the electronic device may acquire at least one latent characteristic. Such a latent characteristic may be a property (e.g., a feature, a vector, etc.) in a latent space defined by the deep learning model and associated with shape images. Specifically, the electronic device may acquire at least one among color characteristics and shape characteristics corresponding to the shape images, based on at least one of the first shape image 4510 and the second shape image 4520.

For example, based on the first shape image 4510, the electronic device may acquire a first color characteristic 4511 related to the color of the first shape image, and a first shape characteristic 4513 (z1) related to the shape of the object included in the first shape image 4510.

Likewise, based on the second shape image 4520, the electronic device may acquire a second color characteristic 4521 related to the color of the second shape image, and a second shape characteristic 4523 (z2) related to the shape of the object included in the second shape image 4520.

Furthermore, the electronic device may output the first processed shape image 4515 from a first output module 4502a, and the second processed shape image 4525 from a second output module 4502b.

Here, the first output module 4502a and the second output module 4502b may include a decoder, an output layer of a neural network, a post-processing model in a deep learning model, etc., but are not limited thereto.

In this case, the electronic device may perform a color transition operation by exchanging color characteristics among the multiple shape images provided as input. Specifically, when the first shape image 4510 and the second shape image 4520 are input, the device may be configured to apply the first color characteristic 4511 of the first shape image to the second shape image, and the second color characteristic 4521 of the second shape image to the first shape image.

More specifically, the electronic device can obtain a first processed shape image 4515 that reflects the first shape characteristic 4513 of the first shape image and the second color characteristic 4521 of the second shape image. In this case, the first processed shape image 4515 may share the shape of the first shape image 4510 and the color of the second shape image 4520.

Similarly, the electronic device can obtain a second processed shape image 4525 that reflects the second shape characteristic 4523 of the second shape image and the first color characteristic 4511 of the first shape image. In that case, the second processed shape image 4525 may share the shape of the second shape image 4520 and the color of the first shape image 4510.

FIG. 46 is a diagram illustrating a training method for a deep learning model aimed at creating a processed shape image by exchanging color characteristics between shape images, according to various embodiments.

To build training data for a deep learning model that enables characteristic exchanges between images, data related to the pixel resetting method described in FIGS. 20-23 and data pertaining to pixel swapping between images described in FIGS. 34-40 may be utilized. For instance, a dataset for training this deep learning model (designed to exchange characteristics among images) may include multiple training data items containing shape images and the color distributions of these shape images. Concretely, the first training data might include a first shape image and a first pixel map representing the color distribution of the first shape image; the second training data might include a second shape image and a second pixel map for its color distribution; and the third training data might include a third shape image that reflects the color characteristics of the first shape image and the shape (positional) characteristics of the second shape image, as well as a third pixel map representing the color distribution of the third shape image.

Referring to FIG. 46, the electronic device may train a deep learning model based on a training dataset that includes multiple shape images and color data corresponding to these shape images. In this scenario, the multiple shape images may share the same shape but exhibit different colors.

Specifically, the electronic device may acquire a training dataset that includes a first shape image 4610, first color data 4611 corresponding to the color of the first shape image, a second shape image 4620 that has the same shape as the first shape image, and second color data 4621 corresponding to the color of the second shape image.

Furthermore, based on this training dataset, the electronic device may train the deep learning model according to predefined learning conditions. Specifically, the device may define multiple learning conditions to acquire a processed image in which color characteristics are exchanged between the input shape images.

To accurately capture the color characteristics of a shape image, the electronic device may set a first learning condition so that the color characteristics in the latent space (which appear when the shape image is input) closely resemble the input color data. Specifically, the first learning condition may be defined based on at least one of the similarity between the first color data 4611 and the first color characteristic 4613 of the first shape image, and the similarity between the second color data 4621 and the second color characteristic 4623 of the second shape image.

In addition, to ensure that the shape image is accurately reconstructed from the latent space, the electronic device may define a second learning condition so that the input shape image and the output image are similar. Specifically, the second learning condition may be defined based on at least one of the similarity between the first shape image 4610 and a first output image 4617, and the similarity between the second shape image 4620 and a second output image 4627.

Also, to ensure that the same shape image yields the same shape characteristic, the electronic device may define a third learning condition so that multiple shape characteristics appearing in the latent space are similar as different shape images are input. Specifically, the third learning condition may be defined based on the similarity between the first shape characteristic 4615 corresponding to the first shape image and the second shape characteristic 4626 corresponding to the second shape image.

FIG. 47 is a diagram illustrating an additional training method for a deep learning model to generate a processed shape image by exchanging color characteristics between shape images, according to various embodiments.

The electronic device may further train the deep learning model based on additional learning conditions to enhance its performance.

Referring to FIG. 47, the electronic device may further include at least one training module for additional training of the deep learning model. This training module could be a data converter made up of a decoder and an encoder, although it is not limited to that configuration.

The electronic device may set a fourth learning condition so that the color characteristics obtained based on the shape image's color attributes remain similar to the input color data. Specifically, the fourth learning condition may be defined based on at least one of (i) the similarity between a third color characteristic 4619, acquired by reconstructing and recompressing the first color characteristic 4613 of the first shape image, and the first color data 4611; and (ii) the similarity between a fourth color characteristic 4629, acquired by reconstructing and recompressing the second color characteristic 4623 of the second shape image, and the second color data 4621.

In addition, the electronic device may define a fifth learning condition so that the shape characteristics obtained based on the shape image's shape attributes remain similar to the existing shape attributes. Specifically, the fifth learning condition may be defined based on at least one of (i) the similarity between a third shape characteristic 4618, acquired by reconstructing and recompressing the first shape characteristic 4615 of the first shape image, and the first shape characteristic 4615 itself; and (ii) the similarity between a fourth shape characteristic 4628, acquired by reconstructing and recompressing the second shape characteristic 4626 of the second shape image, and the second shape characteristic 4625.

FIG. 48 is a flowchart illustrating a method by which an electronic device obtains a processed image by utilizing a color transition function among shape images, according to various embodiments.

Referring to FIG. 48, the electronic device may acquire a first color characteristic defined on a first latent space, based on the first shape image S4810.

Additionally, the electronic device may acquire a first shape characteristic defined on a second latent space, based on the first shape image S4820. In this context, the first and second latent spaces may be spaces of different dimensionalities, but are not limited thereto.

Furthermore, the electronic device may acquire a second color characteristic defined on the first latent space, based on the second shape image S4830.

Additionally, the electronic device may obtain a processed image that reflects the shape of the first shape image and the color of the second shape image, based on the first shape characteristic and the second color characteristic S4840.

As the pixel transition operation between images using the deep learning model of FIG. 45 or FIG. 48 is repeated (iterated), a more complete transition can be achieved.

FIG. 49 is a diagram illustrating a method by which an electronic device performs a pixel transition operation based on user input and provides the outcome, according to various embodiments.

Referring to FIG. 49, the electronic device may provide a pixel transition (or pixel swapping) function through the display 4900 of a user terminal. Specifically, the device may show multiple shape images (4910, 4920) on display 4900, which will have their pixel attributes exchanged with one another.

The electronic device may receive user input related to at least one attribute concerning color exchanges between shape images. It can then control the pixel transition operation between the shape images based on this user input. For instance, the device might receive an iteration count for processing shape images using the deep learning model. Accordingly, based on the iteration count provided by the user, the device can perform pixel transitions between the first shape image 4910 and the second shape image 4920, and display on the screen the first processed shape image set 4915 and the second processed shape image set 4925. The number of shape images included in these processed image sets may correspond to the iteration count entered by the user.

A representative method for exchanging styles between images is style transfer. Style transfer involves extracting features from a particular image and applying or reflecting those features onto another image.

FIG. 50 is a diagram illustrating various methods by which an electronic device can utilize multiple images to obtain a processed image, according to various embodiments.

Referring to FIG. 50, the electronic device may process the first image 5010 and the second image 5020 using at least one of several pre-stored image processing algorithms, thereby acquiring processed images 5031 and 5032.

As one example, the electronic device may obtain a first processed image 5031 by processing the first image 5010 and the second image 5020 based on a pixel swap model 5001. Here, the image processing algorithm rooted in the pixel swap model 5001 can apply the features described in FIGS. 34-49. In other words, the electronic device may maintain the shape-related characteristics of the first image 5010 while transferring the color-related attributes of the second image 5020 to obtain the first processed image 5031.

In another example, the electronic device may process the first image 5010 and second image 5020 based on a style transfer model 5002 to obtain a second processed image 5032. At this time, a generally known style transfer algorithm used by those skilled in the art may be applied as the image processing algorithm underlying the style transfer model 5002. For example, it may involve extracting features from the second image 5020 via a neural network and applying those features to the first image 5010, thus resulting in the second processed image 5032.

In the case of style transfer, only a machine learning-based algorithm is used, whereas in pixel swapping, an algorithm defining the correspondence between pixels is employed. Thus, style transfer typically allows for changes in shape, whereas pixel swapping, which involves mutual exchanges of pixel properties themselves, does not permit changes in shape.

While the embodiments have been described above with reference to limited examples and figures, those skilled in the art will appreciate that various modifications and alterations can be made based on the foregoing disclosure. For example, the technologies described herein can be performed in a different order than described, and/or components of the described system, structure, device, or circuit may be combined or arranged differently than described, or replaced or substituted by other components or their equivalents, while still achieving desired outcomes.

Therefore, other implementations, embodiments, and equivalents to the following claims are also within the scope of the appended claims.

1. An electronic device for providing a pixel-based image processing method, the electronic device comprising:
a display; and
at least one processor;
wherein the at least one processor is configured to:
display a source image using the display;
set at least one region of the source image as a reference position;
obtain a second pixel group by resetting a plurality of pixels included in a first pixel group of the source image based on the reference position; and
display, using the display, a first processed image including the second pixel group.

2. The electronic device of claim 1, wherein the reference position is determined based on a first user input with respect to a specific location corresponding to the at least one region of the source image on the display.

3. The electronic device of claim 1, wherein the at least one processor is further configured to provide, via the display, a first simulation that includes a visual effect in which the positions of a plurality of pixels included in the source image are rearranged.

4. The electronic device of claim 1,
wherein the at least one processor is configured to:
identify a plurality of characteristic values corresponding to a plurality of pixels included in the source image; and
obtain the second pixel group by adjusting at least a portion of the plurality of characteristic values based on the reference position.

5. The electronic device of claim 1, wherein the at least one processor obtains the second pixel group by rearranging positions of the plurality of pixels included in the first pixel group based on the reference position.

6. The electronic device of claim 1,
wherein the at least one processor:
identifies a plurality of characteristic values corresponding to a plurality of pixels included in the source image; and
obtains the second pixel group such that pixels having higher characteristic values are located closer to the reference position.

7. The electronic device of claim 1,
wherein, based on a second user input regarding a first position and a second position on the display respectively corresponding to a first region and a second region of the source image, a specific position that connects the first position and the second position is set as the reference position.

8. The electronic device of claim 1,
wherein the at least one processor is further configured to, upon detecting motion of the electronic device using at least one sensor included the electronic device, provide via the display a second simulation that includes a visual effect in which positions of a plurality of pixels included in the second pixel group of the first processed image are rearranged according to a direction of the detected motion.

9. The electronic device of claim 8,
wherein the at least one processor is further configured to display, via the display, the first processed image when the motion of the electronic device is stopped.

10. The electronic device of claim 1,
wherein a distribution of color-related characteristics of a plurality of pixels included in the second pixel group corresponds to a distribution of color-related characteristics of a plurality of pixels included in the first pixel group.

11. The electronic device of claim 1,
wherein the first processed image is provided as a pixel map in which a plurality of pixels included in the source image are arranged based on characteristics of the plurality of pixels, and
wherein the at least one processor is further configured to obtain a second processed image by adjusting at least a portion of the plurality of pixels included in the source image based on a third user input with respect to the first processed image.

12. The electronic device of claim 11,
wherein, when a color distribution of the first processed image is changed by the third user input, the second processed image is obtained to reflect the changed color distribution.

13. The electronic device of claim 1,
wherein a first processed image is provided as a pixel map in which a plurality of pixels included in the source image are arranged based on characteristics of the plurality of pixels, and
wherein the at least one processor is further configured to obtain at least one among color distribution information, color ratio information, or dominant color information based on the first processed image.

14. The electronic device of claim 13,
wherein the at least one processor is further configured to acquire color similarity information based on at least one among the color distribution information, color ratio information, or dominant color information.

15. The electronic device of claim 13,
wherein the at least one processor is further configured to obtain color recommendation information based on at least one among the color distribution information, color ratio information, or dominant color information.
